(19) United States
(12) Patent Application Publication
(10) Pub. No.: US 2025/0388014 A1
(43) Pub. Date: Dec. 25, 2025

(54) LIQUID EJECTING APPARATUS AND METHOD OF DRIVING LIQUID EJECTING APPARATUS

(71) Applicant: SEIKO EPSON CORPORATION, Tokyo (JP)

(72) Inventor: Masahiro ASAMI, SHIOJIRI-SHI (JP)

(21) Appl. No.: 19/245,498

(22) Filed: Jun. 23, 2025

(30) Foreign Application Priority Data
Jun. 25, 2024 (JP) 2024-101823

(51) Int. Cl. B41J 2/045; B41J 2/14

(52) U.S. Cl. CPC B41J 2/04588; B41J 2/04573; B41J 2/04581; B41J 2/14233

(57) ABSTRACT

A liquid-ejecting-apparatus is configured to eject at least three droplets, which coalesce before landing on a medium from an ejection-section, by using a drive signal including in a unit-time: a at least three ejection-pulses that has respectively a filling element and an ejection element; and at least two coupling elements coupling consecutive ejection-pulses. A period from the start of the filling element to the start of the ejection element in each of the ejection-pulses is in range from 0.3Tc to 0.7Tc, where Tc is a natural vibration period of the ejection-section. Absolute values of electrical potential change ranges of the ejection-elements of the at least three ejection-pulses are great sequentially in the unit time. Electrical potentials maintained by the coupling elements are sequentially close to an electrical potential of an ending edge of a filling element of the last ejection-pulse in the unit time.

The present application is based on, and claims priority from JP Application Serial Number 2024-101823, filed Jun. 25, 2024, the disclosure of which is hereby incorporated by reference herein in its entirety.

### BACKGROUND

### 1. Technical Field

The present disclosure relates to a liquid ejecting apparatus and a method of driving the liquid ejecting apparatus.

### 2. Related Art

A liquid ejecting apparatus represented by an ink jet printer includes a nozzle from which liquid is ejected, a pressure chamber communicating with the nozzle, and a drive element such as a piezoelectric element that changes pressure applied to liquid in the pressure chamber according to a drive signal. In such a liquid ejecting apparatus, for example, as disclosed in JP-A-2017-140761, in order to increase the size of a dot to be formed on a medium, a plurality of droplets may be sequentially ejected from a nozzle so as to coalesce before landing on the medium. Further, JP-A-2017-140761 discloses that a drive voltage for a subsequent droplet is higher than a drive voltage for a preceding droplet. By making the flying speed of the preceding droplet lower than the flying speed of the subsequent droplet, these droplets can coalesce before landing on the medium.

However, in the related art, as the number of droplets that coalesce is increased in order to increase the amount of coalesced liquid, a time interval from the ejection of the first droplet to the ejection of the last droplet becomes longer, and it is difficult to cause the above-described several droplets to coalesce by the time the droplets reach a desired position. On the other hand, when an absolute value of an electrical potential range in which the drive voltage for the preceding droplet changes is reduced in order to lower the flying speed of the preceding droplet and to cause the droplets to coalesce by the time the droplets reach the desired position, the liquid amount of the preceding droplet is reduced, and thus the amount of the coalesced droplets is reduced. That is, in the related art, it is difficult to cause the droplets to coalesce by the time the droplets reach the desired position while securing the amount of the coalesced liquid.

### SUMMARY

According to an aspect of the present disclosure, there is provided a liquid ejecting apparatus that includes: an ejection section including a nozzle from which a droplet is ejected to cause the droplet to land on a medium, a pressure chamber communicating with the nozzle, and a drive element that changes pressure applied to the liquid in the pressure chamber when a drive signal is supplied to the drive element; and a drive signal generator that generates the drive signal. The drive signal includes at least three ejection pulses corresponding to at least three droplets that coalesce before landing on the medium, and each of the at least three ejection pulses includes a filling element that changes an electrical potential to generate negative pressure in the pressure chamber, and an ejection element that changes an electrical potential to generate positive pressure in the pressure chamber and eject a droplet from the nozzle. The drive signal includes at least two coupling elements that couple consecutive ejection pulses among the at least three ejection pulses while maintaining an electrical potential, and a damping element that attenuates residual vibration of the liquid in the pressure chamber by generating negative pressure in the pressure chamber after the droplets are ejected from the nozzle after a last ejection pulse among the at least three ejection pulses. When a natural vibration period of the ejection section is Tc, a period from the start of the filling element to the start of the ejection element in each of the at least three ejection pulses is set to be greater than or equal to 0.3Tc and less than or equal to 0.7Tc, an absolute value of an electrical potential change range of an ejection element of an ejection pulse that is among the at least three ejection pulses and is not a first ejection pulse among the at least three ejection pulses is greater than an absolute value of an electrical potential change range of an ejection element of an ejection pulse that is among the at least three ejection pulses and is before the ejection pulse that is among the at least three ejection pulses and is not the first ejection pulse, a coupling element among the at least two coupling elements maintains an electrical potential of an ending edge of an ejection element of a preceding ejection pulse out of two ejection pulses that are among the at least three ejection pulses and are coupled to a starting edge and an ending edge of the coupling element, and is coupled to a starting edge of a filling element of a subsequent ejection pulse out of the two ejection pulses, and an electrical potential maintained by a coupling element that is among the at least two coupling elements and is not a last coupling element among the at least two coupling elements is between an electrical potential of an ending edge of the filling element of the first ejection pulse and an electrical potential maintained by a coupling element that is among the at least two coupling elements and is after the coupling element that is among the at least two coupling elements and is not the last coupling element.

According to a preferred aspect of the present disclosure, there is provided a method of driving a liquid ejecting apparatus including: an ejection section including an ejection section including a nozzle from which a droplet is ejected to cause the droplet to land on a medium, a pressure chamber communicating with the nozzle, and a drive element that changes pressure applied to the liquid in the pressure chamber when a drive signal is supplied to the drive element; and a drive signal generator that generates the drive signal. The drive signal includes at least three ejection pulses corresponding to at least three droplets that coalesce before landing on the medium, and each of the at least three ejection pulses includes a filling element that changes an electrical potential to generate negative pressure in the pressure chamber, and an ejection element that changes an electrical potential to generate positive pressure in the pressure chamber and eject a droplet from the nozzle. The drive signal includes at least two coupling elements that couple consecutive ejection pulses among the at least three ejection pulses while maintaining an electrical potential, and a damping element that attenuates residual vibration of the liquid in the pressure chamber by generating negative pressure in the pressure chamber after the droplets are ejected from the nozzle after a last ejection pulse among the at least three ejection pulses. When a natural vibration period of the ejection section is Tc, a period from the start of the filling element to the start of the ejection element in each of the at least three ejection pulses is set to be greater than or equal to 0.3Tc and less than or equal to 0.7Tc, an absolute value of an electrical potential change range of an ejection element of an ejection pulse that is among the at least three ejection pulses and is not a first ejection pulse among the at least three ejection pulses is greater than an absolute value of an electrical potential change range of an ejection element of an ejection pulse that is among the at least three ejection pulses and is before the ejection pulse that is among the at least three ejection pulses and is not the first ejection pulse, a coupling element among the at least two coupling elements maintains an electrical potential of an ending edge of an ejection element of a preceding ejection pulse out of two ejection pulses that are among the at least three ejection pulses and are coupled to a starting edge and an ending edge of the coupling element, and is coupled to a starting edge of a filling element of a subsequent ejection pulse out of the two ejection pulses, and an electrical potential maintained by a coupling element that is among the at least two coupling elements and is not a last coupling element among the at least two coupling elements is between an electrical potential of an ending edge of the filling element of the first ejection pulse and an electrical potential maintained by a coupling element that is among the at least two coupling elements and is after the coupling element that is among the at least two coupling elements and is not the last coupling element.

### BRIEF DESCRIPTION OF THE DRAWINGS

FIG. 1 is a schematic diagram illustrating an example of a configuration of a liquid ejecting apparatus according to a first embodiment.

FIG. 2 is a diagram illustrating an electrical configuration of the liquid ejecting apparatus according to the first embodiment.

FIG. 3 is a cross-sectional view illustrating an example of a head chip.

FIG. 4 is a diagram illustrating a switching circuit.

FIG. 5 is a diagram illustrating a drive signal used in the first embodiment.

FIG. 6 is a diagram illustrating a coalesced droplet obtained by coalescence of three droplets sequentially ejected from a nozzle to coalesce.

FIG. 7 is a diagram illustrating a drive signal in a first modification.

FIG. 8 is a diagram illustrating a drive signal in a second modification.

FIG. 9 is a diagram illustrating a drive signal in a third modification.

### DESCRIPTION OF EMBODIMENTS

Hereinafter, embodiments of the present disclosure will be described with reference to the drawings. However, in each of the drawings, a dimension and a scale of each section are different from the actual dimension and scale as appropriate. In addition, since the embodiments described below are preferable specific examples of the present disclosure, various technically preferable limitations are added. However, the scope of the present disclosure is not limited to these embodiments unless otherwise stated to limit the present disclosure in the following description.

### A. First Embodiment

### A1. Overall Configuration of Liquid Ejecting Apparatus

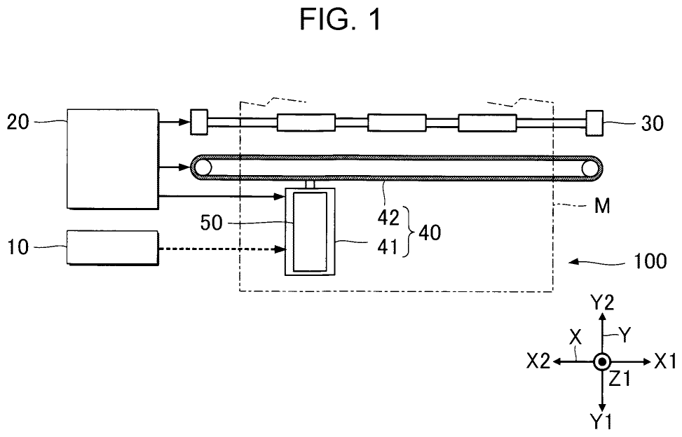

FIG. 1 is a schematic diagram illustrating an example of a configuration of a liquid ejecting apparatus 100 according to a first embodiment. The liquid ejecting apparatus 100 is an ink jet type printing apparatus that ejects liquid, such as ink, as a droplet onto a medium M. The medium M is, for example, a printing sheet. The medium M is not limited to the printing sheet, and may be, for example, a printing object made of any material such as a resin film or fabric.

As illustrated in FIG. 1, the liquid ejecting apparatus 100 includes a liquid container 10, a control unit 20, a transport mechanism 30, a moving mechanism 40, and a head 50.

The liquid container 10 stores ink. Specific examples of the liquid container 10 include a cartridge that is attachable to and detachable from the liquid ejecting apparatus 100, a bag-shaped ink pack that is formed of a flexible film, and an ink tank that can be replenished with ink. A type of the ink stored in the liquid container 10 is optional.

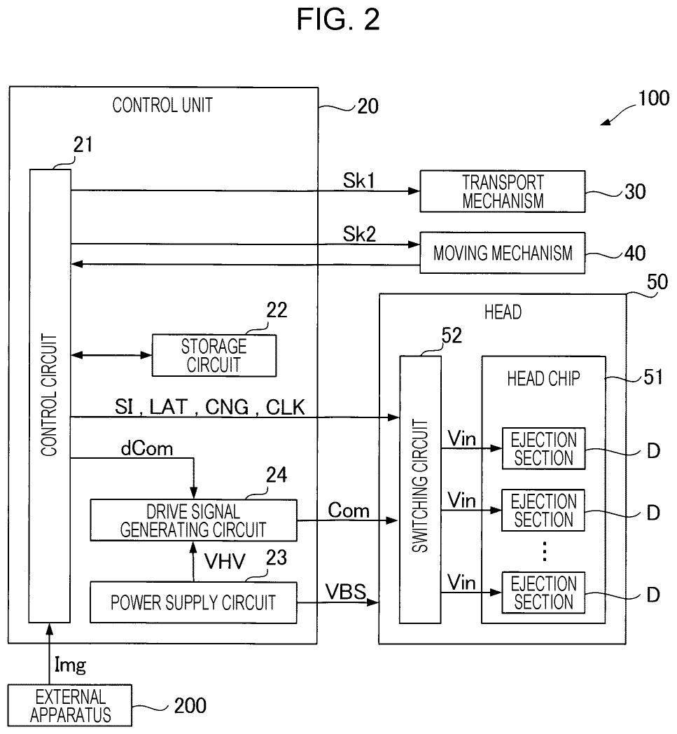

The control unit 20 controls an operation of each component of the liquid ejecting apparatus 100. The control unit 20 includes, for example, one or more processing circuits, such as a central processing unit (CPU) or a field programmable gate array (FPGA), and one or more storage circuits, such as a semiconductor memory. A detailed configuration of the control unit 20 will be described later with reference to FIG. 2.

The transport mechanism 30 transports the medium M in a Y1 direction under control by the control unit 20. The moving mechanism 40 causes the head 50 to reciprocate along an X axis under control by the control unit 20. The moving mechanism 40 includes a substantially box-shaped carriage 41 housing the head 50, and an endless transport belt 42 to which the carriage 41 is fixed. The number of heads 50 mounted on the carriage 41 is not limited to one, and may be greater than or equal to two. Further, the liquid container 10 described above may be mounted on the carriage 41 in addition to the head 50.

The head 50 ejects the ink supplied from the liquid container 10 onto the medium M from each of a plurality of nozzles N under control by the control unit 20. The ejection is performed in parallel with the transport of the medium M by the transport mechanism 30 and the reciprocating movement of the head 50 by the moving mechanism 40, and thus the ink forms an image on a front surface of the medium M.

### A2. Electrical Configuration of Liquid Ejecting Apparatus

FIG. 2 is a diagram illustrating an electrical configuration of the liquid ejecting apparatus 100 according to the first embodiment. Before description of the control unit 20 with reference to FIG. 2, the head 50 will be briefly described.

As illustrated in FIG. 2, the head 50 includes a head chip 51 and a switching circuit 52.

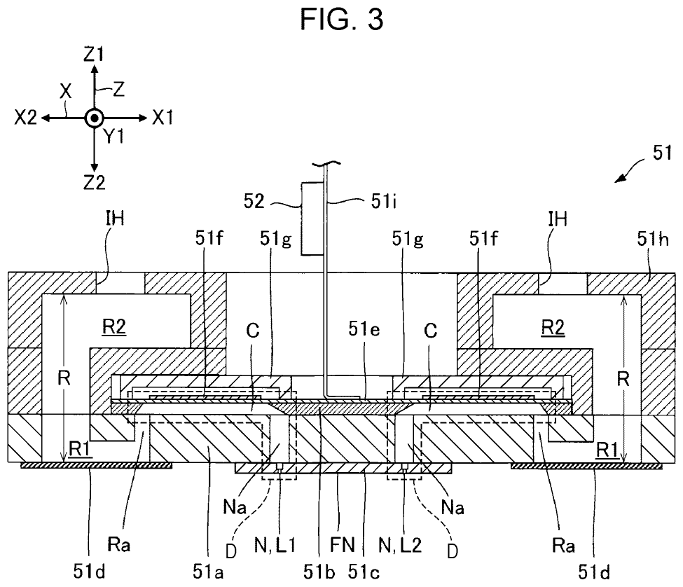

The head chip 51 includes a plurality of ejection sections D, and ejects the ink from the nozzles N by appropriately driving the plurality of ejection sections D. Each of the ejection sections D applies pressure to the ink in response to the supply of a supply signal Vin. Details of the head chip 51 will be described later with reference to FIGS. 3 to 5.

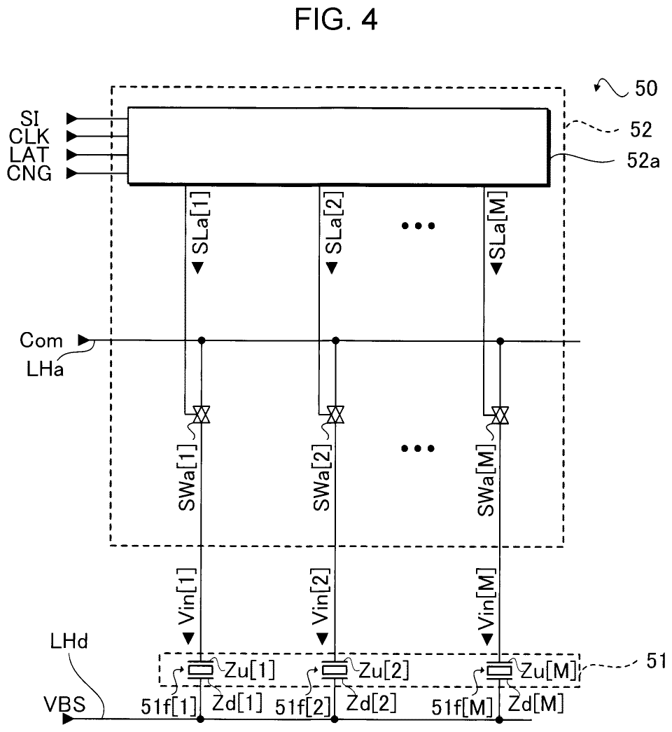

The switching circuit 52 switches whether or not to supply a drive signal Com output from the control unit 20 as the supply signal Vin to each of the plurality of ejection sections D included in the head chip 51 under control by the control unit 20. Details of the switching circuit 52 will be described later with reference to FIG. 4.

In the example illustrated in FIG. 2, the number of head chips 51 included in the head 50 is one, but is not limited thereto and may be greater than or equal to two. Hereinafter, when the number of nozzles N included in the head chip 51 is M, each of the ejection sections D may be denoted as an ejection section D[m] using a suffix [m] in order to distinguish the M ejection sections D corresponding to the M nozzles. In this case, M is an integer greater than or equal to 1, and m is an integer greater than or equal to 1 and less than or equal to M. In addition, in the liquid ejecting apparatus 100, the suffix [m] may also be used for components included in the ejection section D[m].

As illustrated in FIG. 2, the control unit 20 includes a control circuit 21, a storage

circuit 22, a power supply circuit 23, and a drive signal generating circuit 24 that is an example of a “drive signal generator”.

The control circuit 21 has a function of controlling an operation of each of sections of the liquid ejecting apparatus 100 and a function of processing various data. The control circuit 21 includes, for example, a processor such as one or more central processing units (CPUs). The control circuit 21 may include a programmable logic device such as a field-programmable gate array (FPGA) instead of the one or more CPUs or in addition to the one or more CPUs. In a case where the control circuit 21 includes a plurality of processors, the plurality of processors may be mounted on different substrates or the like.

The storage circuit 22 stores various programs to be executed by the control circuit 21 and various data such as print data Img to be processed by the control circuit 21. The storage circuit 22 includes, for example, one or both of semiconductor memories that are a volatile memory such as a random-access memory (RAM) and a non-volatile memory such as a read-only memory (ROM), an electrically erasable programmable read-only memory (EEPROM), or a programmable ROM (PROM). The print data Img is supplied from an external apparatus 200 such as a personal computer or a digital camera. The storage circuit 22 may be configured as a portion of the control circuit 21.

The power supply circuit 23 receives power supplied from a commercial power supply (not illustrated) and generates various predetermined electrical potentials. The generated various electrical potentials are appropriately supplied to the sections of the liquid ejecting apparatus 100. For example, the power supply circuit 23 generates a power supply electrical potential VHV and an offset electrical potential VBS. The offset electrical potential VBS is supplied to the head 50. The power supply electrical potential VHV is supplied to the drive signal generating circuit 24.

The drive signal generating circuit 24 generates the drive signal Com for driving each of the ejection sections D. Specifically, the drive signal generating circuit 24 includes, for example, a digital-to-analog (DA) conversion circuit and an amplifier circuit. In the drive signal generating circuit 24, the DA conversion circuit converts a waveform specifying signal dCom from the control circuit 21 from a digital signal to an analog signal, and the amplifier circuit generates the drive signal Com by amplifying the analog signal using the power supply potential VHV from the power supply circuit 23. In this case, a signal having a waveform that is included in a waveform included in the drive signal Com and is actually supplied to one or more of the ejection sections D is the supply signal Vin described above. The waveform specifying signal dCom is a digital signal for defining the waveform of the drive signal Com.

The control circuit 21 executes a program stored in the storage circuit 22 to control the operation of each of the sections of the liquid ejecting apparatus 100. The control circuit 21 generates, as signals for controlling the operation of each of the sections of the liquid ejecting apparatus 100, control signals Sk1 and Sk2, a print data signal SI, the waveform specifying signal dCom, a latch signal LAT, a change signal CNG, and a clock signal CLK by executing the program.

The control signal Sk1 is a signal for controlling the driving of the transport mechanism 30. The control signal Sk2 is a signal for controlling the driving of the moving mechanism 40. The print data signal SI is a digital signal for specifying operation states of the ejection sections D. The latch signal LAT and the change signal CNG are used together with the print data signal SI, and are timing signals that define the timing of ejecting the ink from each of the nozzles of the head chip 51. These timing signals are generated, for example, based on output of an encoder that detects the position of the carriage 41 described above.

### A3. Specific Structure of Head Chip

FIG. 3 is a cross-sectional view illustrating an example of the head chip 51. As illustrated in FIG. 3, the head chip 51 includes the plurality of nozzles N arranged in a direction along a Y axis. The plurality of nozzles N are divided into a first row L1 and a second row L2 that are arranged at an interval in a direction along the X axis. Each of the first row L1 and the second row L2 is a set of a plurality of nozzles N linearly arranged in the direction along the Y axis.

The head chip 51 has a substantially symmetrical configuration in the direction along the X axis. However, positions of the plurality of nozzles N in the first row L1 in the direction along the Y axis may match or differ from positions of the plurality of nozzles N in the second row L2 in the direction along the Y axis. FIG. 3 illustrates a configuration in which the positions of the plurality of nozzles N in the first row L1 in the direction along the Y axis match the positions of the plurality of nozzles N in the second row L2 in the direction along the Y axis.

As illustrated in FIG. 3, the head chip 51 includes a flow path substrate 51a, a pressure chamber substrate 51b, a nozzle plate 51c, a vibration absorbing body 51d, a vibration plate 51e, a plurality of drive elements 51f, a protective plate 51g, a case 51h, and a wiring substrate 51i.

The flow path substrate 51a and the pressure chamber substrate 51b are stacked in this order in a Z1 direction, and form a flow path for supplying the ink to the plurality of nozzles N. The vibration plate 51e, the plurality of drive elements 51f, the protective plate 51g, the case 51h, and the wiring substrate 51i are disposed in a region located in the Z1 direction with respect to a stacked body formed by stacking the flow path substrate 51a and the pressure chamber substrate 51b. Meanwhile, the nozzle plate 51c and the vibration absorbing body 51d are disposed in a region located in a Z2 direction with respect to the stacked body. Each of the components of the head chip 51 is schematically a plate-shaped member elongated in the Y direction, and the components of the head chip 51 are bonded to each other via, for example, an adhesive. The components of the head chip 51 will be described in order.

The nozzle plate 51c is a plate-shaped member in which the plurality of nozzles N in each of the first row L1 and the second row L2 are disposed. Each of the plurality of nozzles N is a through-hole through which the ink passes. In this case, a surface of the nozzle plate 51c facing the Z2 direction is a nozzle surface FN. For example, the nozzle plate 51c is manufactured by processing a silicon single crystal substrate by using, for example, a semiconductor manufacturing technique using a processing technique such as dry etching or wet etching. However, other known methods and materials may be suitably used to manufacture the nozzle plate 51c. In addition, the cross-sectional shape of each of the nozzles is typically a circular shape, but is not limited thereto, and may be a non-circular shape such as a polygonal shape or an elliptical shape.

In the flow path substrate 51a, a space R1, a plurality of supply flow paths Ra, and a plurality of communication flow paths Na are disposed for each of the first row L1 and the second row L2. The space R1 is an elongated opening extending in the direction along the Y axis in plan view as viewed from a direction along a Z axis. Each of the supply flow paths Ra and each of the communication flow paths Na are through-holes formed for each of the nozzle N. Each of the supply flow paths Ra communicates with the space R1.

The pressure chamber substrate 51b is a plate-shaped member in which a plurality of pressure chambers C, which are called cavities, are disposed for each of the first row L1 and the second row L2. The plurality of pressure chambers C are arranged in the direction along the Y axis. Each of the pressure chambers C is an elongated space formed for a respective one of the nozzles N and extending in the direction along the X axis in plan view. Similarly to the nozzle plate 51c described above, each of the flow path substrate 51a and the pressure chamber substrate 51b is manufactured by processing a silicon single crystal substrate by using, for example, a semiconductor manufacturing technique. However, other known methods and materials may be appropriately used for manufacturing each of the flow path substrate 51a and the pressure chamber substrate 51b.

The pressure chambers C are spaces located between the flow path substrate 51a and the vibration plate 51e. For each of the first row L1 and the second row L2, the plurality of pressure chambers C are arranged in the direction along the Y axis. In addition, the pressure chambers C communicate with the respective communication flow paths Na and the respective supply flow paths Ra. Therefore, the pressure chambers C communicate with the nozzles N through the communication flow paths Na and communicate with the space R1 through the supply flow paths Ra.

The vibration plate 51e is disposed on a surface of the pressure chamber substrate 51b facing the Z1 direction. The vibration plate 51e is a plate-like member that can elastically vibrate. The vibration plate 51e includes, for example, a first layer and a second layer that are stacked in the Z1 direction in this order. The first layer is, for example, an elastic film made of silicon oxide (SiO₂). The elastic film is formed by, for example, thermally oxidizing one surface of a silicon single crystal substrate. The second layer is, for example, an insulating film made of zirconium oxide (ZrO₂). The insulating film is formed by, for example, forming a zirconium layer using a sputtering method and thermally oxidizing the layer. In addition, the vibration plate 51e is not limited to the above-described configuration in which the first layer and the second layer are stacked, and for example, may include only a single layer, or may include three or more layers.

On a surface of the vibration plate 51e facing the Z1 direction, the plurality of drive elements 51f corresponding to the nozzles N are arranged for each of the first row L1 and the second row L2. Each of the drive elements 51f is a passive element that is deformed by the supply of the drive signal. Each of the drive elements 51f has an elongated shape extending in the direction along the X axis in plan view. The plurality of drive elements 51f are arranged in the direction along the Y axis to correspond to the plurality of pressure chambers C. The drive elements 51f overlap the pressure chambers C in plan view.

Each of the drive elements 51f is a piezoelectric element. Although not illustrated, each of the drive elements 51f includes a first electrode, a piezoelectric layer, and a second electrode that are stacked in the Z1 direction in this order. Either the first electrodes or the second electrodes are individual electrodes separated from each other for each of the drive elements 51f, and the supply signal Vin is applied to the individual electrodes. The other electrodes that are the first electrodes or the second electrodes and are not the individual electrodes are a band-shaped common electrode extending in the direction along the Y axis so as to be continuous over the plurality of drive elements 51f, and the offset electrical potential VBS is supplied to the other electrodes. Examples of a metal material of these electrodes include metal materials such as platinum (Pt), aluminum (Al), nickel (Ni), gold (Au), and copper (Cu), and among these, one type can be used alone, or two or more types can be used in combination in the form of an alloy, a laminate, or the like. The piezoelectric layers are formed of a piezoelectric material such as lead zirconate titanate (Pb(Zr, Ti)O₃) and have, for example, a band shape extending in the direction along the Y axis so as to be continuous over the plurality of drive elements 51f. However, the piezoelectric layers may be integrated over the plurality of drive elements 51f. In this case, in each of the piezoelectric layers, in a region corresponding to a gap between the pressure chambers C adjacent to each other in plan view, a through-hole penetrating the piezoelectric layer is disposed extending in the direction along the X axis. When the vibration plate 51e vibrates in conjunction with the deformation of the drive elements 51f, the pressure in the pressure chambers C changes, and thus the ink is ejected from the nozzles N.

The protective plate 51g is a plate-shaped member disposed on the surface of the vibration plate 51e facing the Z1 direction, protects the plurality of drive elements 51f, and reinforces the mechanical strength of the vibration plate 51e. The plurality of drive elements 51f are disposed between the protective plate 51g and the vibration plate 51e. The protective plate 51g is made of, for example, a resin material.

The case 51h is a member for storing the ink to be supplied to the plurality of pressure chambers C. The case 51h is made of, for example, a resin material. A space R2 is disposed in the case 51h for each of the first row L1 and the second row L2. The spaces R2 communicate with the space R1 and function as reservoirs R for storing the ink to be supplied to the plurality of pressure chambers C together with the space R1. The case 51h is provided with an inlet IH for supplying the ink to each of the reservoirs R. The ink in each of the reservoirs R is supplied to the pressure chambers C through each of the supply flow paths Ra.

The vibration absorbing body 51d, which is also referred to as a compliance substrate, is a flexible resin film constituting a wall surface of the reservoirs R, and reduces a fluctuation in pressure applied to the ink in the reservoirs R. The vibration absorbing body 51d may be a flexible thin metal plate. A surface of the vibration absorbing body 51d facing the Z1 direction is bonded to the flow path substrate 51a via an adhesive or the like.

The wiring substrate 51i is a mounted component that is mounted on the surface of the vibration plate 51e facing the Z1 direction and electrically couples the control unit 20 and the head chip 51. The wiring substrate 51i is, for example, a flexible wiring substrate such as a chip on film (COF), a flexible printed circuit (FPC), or a flexible flat cable (FFC). The switching circuit 52 for supplying a drive voltage to each of the drive elements 51f is mounted on the wiring substrate 51i according to the present embodiment.

As illustrated in FIG. 3, each of the ejection sections D includes one drive element 51f, one pressure chamber C, and one nozzle N. That is, the M drive elements 51f correspond to the M pressure chambers C in a one-to-one manner. As is understood from FIG. 3 and the like, the drive elements 51f corresponding to the pressure chambers C overlap portions or all of the pressure chambers C in plan view as viewed in the Z2 direction. When the drive signal Com is supplied to the drive elements 51f based on the print data signal SI, the drive elements 51f are driven by the drive signal Com to cause the ejection sections D to eject the ink in the pressure chambers C from the nozzles N.

### A4. Driving of Drive Elements 51f

FIG. 4 is a diagram illustrating the switching circuit 52. Each of the drive elements 51f is driven by the supply signal Vin from the switching circuit 52. The switching circuit 52 will be described below with reference to FIG. 4.

As illustrated in FIG. 4, wiring LHa is coupled to the switching circuit 52. The wiring LHa is a signal line through which the drive signal Com is transmitted. FIG. 4 illustrates either the first electrodes or the second electrodes of the drive elements 51f as electrodes Zd[m], and illustrates the other electrodes as electrodes Zu[m]. Wiring LHd is coupled to the electrodes Zd[m]. The wiring LHd is a power supply line through which the offset electrical potential VBS is supplied.

The switching circuit 52 includes switches SWa[1] to SWa[M] that are M switches SWa, and a coupling state specifying circuit 52a that specifies coupling states of these switches SWa.

The switches SWa[m] are switches for switching between conduction and non-conduction between the wiring LHa for transmitting the drive signal Com and the electrodes Zu[m] of the drive elements 51f[m]. Each of these switches is, for example, a transmission gate.

The coupling state specifying circuit 52a generates, based on the clock signal CLK, the print data signal SI, the latch signal LAT, and the change signal CNG supplied from the control circuit 21, coupling state specifying signals SLa[1] to SLa[M] for specifying whether to turn on or off the switches SWa[1] to SWa[M], respectively.

For example, although not illustrated, the coupling state specifying circuit 52a includes a plurality of transfer circuits, a plurality of latch circuits, and a plurality of decoders such that sets of the plurality of transfer circuits, the plurality of latch circuits, and the plurality of decoders correspond to the drive elements 51f[1] to 51f[M] in a one-to-one manner. The print data signal SI is supplied to the transfer circuits among these circuits. The print data signal SI includes individual specifying signals for the respective drive elements 51f. The individual specifying signals are serially supplied and are, for example, sequentially transferred to the plurality of transfer circuits in synchronization with the clock signal CLK. The latch circuits latch, based on the latch signal LAT, the individual specifying signals supplied to the transfer circuits. Further, the decoders generate coupling state specifying signals SLa[m] based on the individual specifying signals, the latch signal LAT, and the change signal CNG.

The switches SWa[m] are turned on and off in accordance with the coupling state specifying signals SLa[m] generated as described above. For example, the switches SWa[m] are in an ON state when the coupling state specifying signals SLa[m] are at a high level, and are in an OFF state when the coupling state specifying signals SLa[m] are at a low level. As described above, the switching circuit 52 supplies a portion or all of the waveform included in the drive signal Com as the supply signal Vin to one or more drive elements 51f of one or more ejection sections D selected from among the M ejection sections D.

### A5. Drive Signal

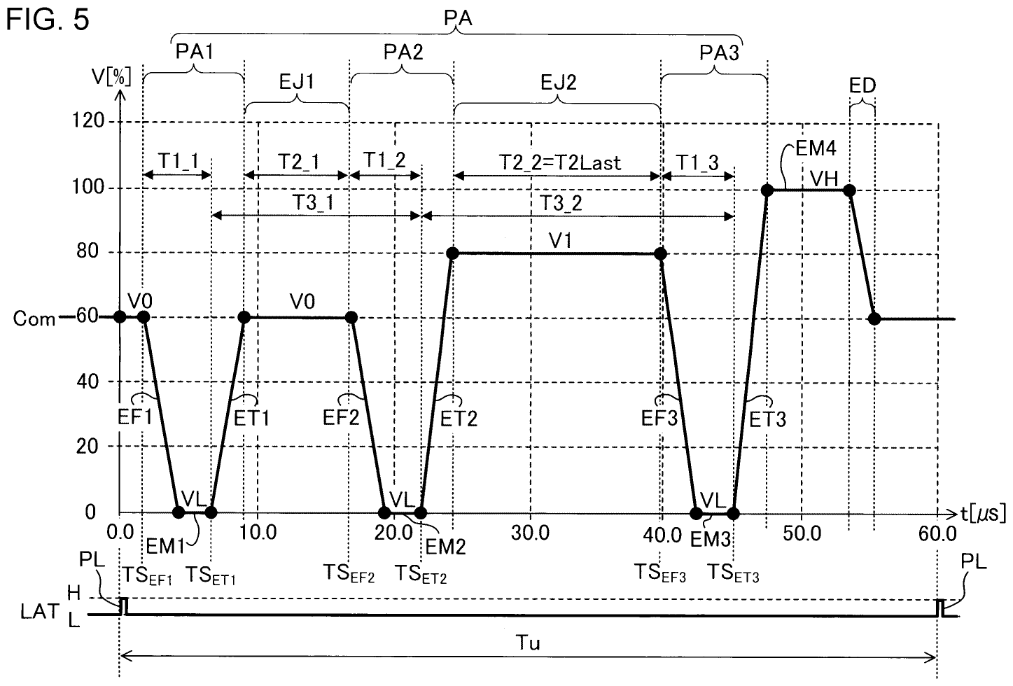

FIG. 5 is a diagram illustrating the drive signal Com used in the first embodiment. As illustrated in FIG. 5, the latch signal LAT includes a pulse PL for defining a unit period Tu. The unit period Tu corresponds to a printing period in which a dot is formed on the medium M with the ink from the nozzle N. The unit period Tu is defined as, for example, a period from a rising edge of the pulse PL to a next rising edge of the pulse PL. A specific length of the unit period Tu is not particularly limited. In the present embodiment, the length of the unit period Tu is about 60 μs. In this case, us represents microseconds. In addition, in FIG. 5, when the lowest electrical potential VL available for the drive signal Com is set as an electrical potential of 0% and the highest electrical potential VH available for the drive signal Com is set as an electrical potential of 100%, the electrical potential of the drive signal Com is in an electrical potential range from 0% to 100%. For example, the difference between the electrical potential of 0% and the electrical potential of 100% is 42 V. In this case, V represents volt, which is a unit representing an electrical potential.

The drive signal Com in the present embodiment includes a first ejection pulse PA1, a first coupling element EJ1, a second ejection pulse PA2, a second coupling element EJ2, a third ejection pulse PA3, an electrical potential maintained element EM4, and a damping element ED in this order in the unit period Tu.

Each of the first ejection pulse PA1, the second ejection pulse PA2, and the third ejection pulse PA3 may be referred to as an ejection pulse PA. Each of the first coupling element EJ1 and the second coupling element EJ2 may be referred to as a coupling element EJ.

The first ejection pulse PA1, the second ejection pulse PA2, and the third ejection pulse PA3 are three ejection pulses PA for sequentially ejecting, from the nozzle N, three droplets that coalesce after being ejected from the nozzle N and before landing on the medium M. The three ejection pulses PA are aligned in order of time corresponding to the three droplets. Each of the first coupling element EJ1 and the second coupling element EJ2 is between two consecutive ejection pulses PA among the three ejection pulses PA.

The three ejection pulses PA are an example of “at least three ejection pulses”. The three droplets are an example of “at least three droplets”. The two coupling elements EJ are an example of “at least two coupling elements”. The number of coupling elements EJ is less than the number of ejection pulses PA by one.

Each of the ejection pulses PA is an electrical potential pulse for driving the drive element 51f so as to change the pressure applied to the ink in the pressure chamber C such that the pressure becomes high enough to eject the ink from the nozzle N. When each of the ejection pulses PA is supplied to the drive element 51f, the ink is ejected from the nozzle N as a droplet.

More specifically, the first ejection pulse PA1 is the first ejection pulse PA among the three ejection pulses PA in the unit period Tu. In the example illustrated in FIG. 5, the first ejection pulse PA1 includes a filling element EF1 and an ejection element ET1 in this order. Note that the filling element EF1 and the ejection element ET1 are coupled to each other via an electrical potential maintained element EM1 that maintains the lowest electrical potential VL. The filling element EF1 changes from a reference electrical potential V0 to the lowest electrical potential VL. The reference electrical potential V0 is an electrical potential at the start of the unit period Tu. In the example illustrated in FIG. 5, the reference electrical potential V0 is an electrical potential of about 60%. The lowest electrical potential VL is lower than the reference electrical potential V0. The ejection element ET1 is coupled to the first coupling element EJ1 by changing from the lowest electrical potential VL to the reference electrical potential V0.

As described above, the first ejection pulse PA1 is an electrical potential pulse having a waveform in which the electrical potential changes from the reference electrical potential V0 to the lowest electrical potential VL to the reference electrical potential V0. When the first ejection pulse PA1 is supplied to the drive element 51f, the drive element 51f generates negative pressure in the pressure chamber C based on the filling element EF1, and then generates positive pressure in the pressure chamber C based on the ejection element ET1 so as to cause a droplet to be ejected from the nozzle N. When the negative pressure is generated in the pressure chamber C, the surface of the ink in the nozzle N is drawn in a direction opposite to an ejection direction in which the droplet is ejected. Hereinafter, the surface of the ink in the nozzle N may be referred to as a “meniscus”. Further, drawing the meniscus in the direction opposite to the ejection direction may be referred to as “pull”. When the positive pressure is generated in the pressure chamber C, the meniscus is pushed out in the ejection direction. Hereinafter, pushing out the meniscus in the ejection direction may be referred to as “push”. Further, as can be understood from the above description, in the present embodiment, negative pressure is generated in the pressure chamber C by decreasing the electrical potential supplied to the drive element 51f, and positive pressure is generated in the pressure chamber C by increasing the electrical potential supplied to the drive element 51f. Decreasing the electrical potential and increasing the electrical potential are examples of “changing an electrical potential”.

The first ejection pulse PA1 is coupled to the second ejection pulse PA2 via the first coupling element EJ1. In the example illustrated in FIG. 5, the starting edge of the first coupling element EJ1 is coupled to the ending edge of the ejection element ET1 of the first ejection pulse PA1. The first coupling element EJ1 maintains the reference electrical potential V0.

The second ejection pulse PA2 is the second ejection pulse PA among the three ejection pulses PA in the unit period Tu. In the example illustrated in FIG. 5, the second ejection pulse PA2 includes a filling element EF2 and an ejection element ET2 in this order. The filling element EF2 and the ejection element ET2 are coupled to each other via an electrical potential maintained element EM2 that maintains the lowest electrical potential VL. The filling element EF2 changes from the reference electrical potential V0 to the lowest electrical potential VL. The ejection element ET2 is coupled to the second coupling element EJ2 by changing from the lowest electrical potential VL to an electrical potential V1. The electrical potential V1 is between the reference electrical potential V0 and the highest electrical potential VH. In the example illustrated in FIG. 5, the electrical potential V1 is an electrical potential of about 80%.

As described above, the second ejection pulse PA2 is an electrical potential pulse having a waveform in which the electrical potential changes from the reference electrical potential V0 to the lowest electrical potential VL to the electrical potential V1. When the second ejection pulse PA2 is supplied to the drive element 51f, the drive element 51f generates negative pressure in the pressure chamber C based on the filling element EF2, and then generates positive pressure in the pressure chamber C based on the ejection element ET2 so as to cause a droplet to be ejected from the nozzle N.

The second ejection pulse PA2 is coupled to the third ejection pulse PA3 via the second coupling element EJ2. In the example illustrated in FIG. 5, the starting edge of the second coupling element EJ2 is coupled to the ending edge of the ejection element ET2 of the second ejection pulse PA2. The second coupling element EJ2 maintains the electrical potential V1.

The third ejection pulse PA3 is the last ejection pulse PA among the three ejection pulses PA in the unit period Tu. In the example illustrated in FIG. 5, the third ejection pulse PA3 includes a filling element EF3 and an ejection element ET3 in this order. The filling element EF3 and the ejection element ET3 are coupled to each other via an electrical potential maintained element EM3 that maintains the lowest electrical potential VL. The filling element EF3 changes from the electrical potential V1 to the lowest electrical potential VL. The ejection element ET3 is coupled to the electrical potential maintained element EM4 by changing from the lowest electrical potential VL to the highest electrical potential VH.

As described above, the third ejection pulse PA3 is an electrical potential pulse having a waveform in which the electrical potential changes from the electrical potential V1 to the lowest electrical potential VL to the highest electrical potential VH. When the third ejection pulse PA3 is supplied to the drive element 51f, the drive element 51f generates negative pressure in the pressure chamber C based on the filling element EF3, and then generates positive pressure in the pressure chamber C based on the ejection element ET3 so as to cause a droplet to be ejected from the nozzle N.

The third ejection pulse PA3 is coupled to the damping element ED via the electrical potential maintained element EM4. In the example illustrated in FIG. 5, the starting edge of the electrical potential maintained element EM4 is coupled to the ending edge of the ejection element ET3 of the third ejection pulse PA3. The electrical potential maintained element EM4 maintains the highest electrical potential VH.

The damping element ED attenuates residual vibration of the ink in the pressure chamber C by generating negative pressure in the pressure chamber C after the droplets are ejected from the nozzle N. The damping element ED changes from the highest electrical potential VH to the reference electrical potential V0.

Hereinafter, each of the filling elements EF1, EF2, and EF3 may be referred to as a filling element EF. Each of the ejection elements ET1, ET2, and ET3 may be referred to as an ejection element ET.

Each of the three ejection pulses PA included in the drive signal Com according to the embodiment has a so-called pull-push waveform. However, since the damping element ED that generates the negative pressure in the pressure chamber C is present after the third ejection pulse PA3 that is the last ejection pulse PA, when the third ejection pulse PA3 and the damping element ED are treated as one pulse, this pulse can be regarded as a so-called pull-push-pull waveform.

As illustrated in FIG. 5, a period T1_1 from the start time TS_{EF1} of the filling element EF1 of the first ejection pulse PA1 to the start time TS_{ET1} of the ejection element ET1 of the first ejection pulse PA1 is set to be greater than or equal to 0.3Tc and less than or equal to 0.7Tc, and is preferably as close to 0.5Tc as possible. Tc is the natural vibration period of the ejection section D. Similarly, a period T1_2 from the start time TS_{EF2} of the filling element EF2 of the second ejection pulse PA2 to the start time TS_{ET2} of the ejection element ET2 of the second ejection pulse PA2 is set to be greater than or equal to 0.3Tc and less than or equal to 0.7Tc, and is preferably as close to 0.5Tc as possible. In addition, a period T1_3 from the start time TS_{EF3} of the filling element EF3 of the third ejection pulse PA3 to the start time TS_{ET3} of the ejection element ET3 of the third ejection pulse PA3 is set to be greater than or equal to 0.3Tc and less than or equal to 0.7Tc, and is preferably as close to 0.5Tc as possible. Hereinafter, each of the periods T1_1, T1_2, and T1_3 may be referred to as a period T1. To summarize the above description, the periods T1 are set to be greater than or equal to 0.3Tc and less than or equal to 0.7Tc, and are preferably as close to 0.5Tc as possible.

In addition, an absolute value of an electrical potential change range of an ejection element ET of a certain ejection pulse PA among the ejection pulses PA is greater as the certain ejection pulse PA is supplied later. Specifically, the absolute value of the electrical potential change range of the ejection element ET1 is V0-VL, the absolute value of the electrical potential change range of the ejection element ET2 is V1-VL, and V1 is higher than V0. Therefore, the absolute value of the electrical potential change range of the ejection element ET2 is greater than the absolute value of the electrical potential change range of the ejection element ET1. Further, the absolute value of the electrical potential change range of the ejection element ET3 is VH-VL, and VH is higher than V1. Therefore, the absolute value of the electrical potential change range of the ejection element ET3 is greater than the absolute value of the electrical potential change range of the ejection elements ET2. In the first embodiment, when the second ejection pulse PA2 corresponds to an “ejection pulse that is among the at least three ejection pulses and is not a first ejection pulse among the at least three ejection pulses”, the first ejection pulse PA1 corresponds to an “ejection pulse that is among the at least three ejection pulses and is before the ejection pulse that is among the at least three ejection pulses and is not the first ejection pulse”. In addition, when the third ejection pulse PA3 corresponds to an “ejection pulse that is among the at least three ejection pulses and is not a first ejection pulse among the at least three ejection pulses”, each of the first ejection pulse PA1 and the second ejection pulse PA2 corresponds to an “ejection pulse that is among the at least three ejection pulses and is before the ejection pulse that is among the at least three ejection pulses and is not the first ejection pulse”.

As can be understood from the above description, each of the two coupling elements EJ maintains an electrical potential of an ending edge of an ejection element ET of a preceding ejection pulse PA out of two ejection pulses PA coupled to a starting edge and an ending edge of the coupling element EJ among the ejection pulses PA, and is coupled to a starting edge of a filling element EF of the subsequent ejection pulse PA out of the two ejection pulses PA. Each of the first coupling element EJ1 and the second coupling element EJ2 corresponds to a “coupling element among the at least two coupling elements”.

In addition, the reference electrical potential V0 that is the electrical potential maintained by the first coupling element EJ1 is between the lowest electrical potential VL that is the electrical potential of the ending edge of the filling element EF1 of the first ejection pulse PA1 that is the first ejection pulse PA among the three ejection pulses PA and the electrical potential V1 maintained by the second coupling element EJ2 that is after the first coupling element EJ1. In the first embodiment, the first coupling element EJ1 corresponds to a “coupling element that is among the at least two coupling elements and is not a last coupling element among the at least two coupling elements”, and the second coupling element EJ2 corresponds to a “coupling element that is among the at least two coupling elements and is after a coupling element that is among the at least two coupling elements and is not the last coupling element”.

In addition, as is understood from FIG. 5, the reference electrical potential V0 that is the electrical potential of the ending edge of the ejection element ET1 of the first ejection pulse PA1 that is the first ejection pulse PA among the three ejection pulses PA is equal to the reference electrical potential V0 that is the electrical potential of the starting edge of the filling element EF1. In the present disclosure, a case where “two electrical potentials are equal to each other” includes not only a case where the two electrical potentials completely match but also a case where the two electrical potentials can be regarded as being equal to each other if an error is taken into account. In addition, in each of the second and subsequent ejection pulses PA among the three ejection pulses PA, the absolute value of the electrical potential change range of the ejection element ET is greater than the absolute value of the electrical potential change range of the filling element EF. Specifically, the absolute value of the electrical potential change range of the ejection element ET2 of the second ejection pulse PA2 that is the second ejection pulse PA is V1-VL, and the absolute value of the electrical potential change range of the filling element EF2 of the second ejection pulse PA2 is V0-VL. Therefore, the absolute value of the electrical potential change range of the ejection element ET2 is greater than the absolute value of the electrical potential change range of the filling element EF2. Similarly, the absolute value of the electrical potential change range of the ejection element ET3 of the third ejection pulse PA3 that is the third ejection pulse PA is VH-VL, and the absolute value of the electrical potential change range of the filling element EF2 of the third ejection pulse PA3 is V1-VL. VH is higher than V1. Therefore, the absolute value of the electrical potential change range of the ejection element ET3 is greater than the absolute value of the electrical potential change range of the filling element EF3.

That is, in the first ejection pulse PA1, the electrical potential immediately after the push and the electrical potential immediately before the pull are the same at the reference electrical potential V0. In the intermediate second ejection pulse PA2 among the three ejection pulses PA, the electrical potential immediately after the push is set to be higher than the electrical potential immediately before the pull. In the third ejection pulse PA3 that is the last ejection pulse PA, the electrical potential change range is set to the maximum range available for the drive signal Com, that is, the range from the lowest electrical potential VL to the highest electrical potential VH. Therefore, the speed of a droplet ejected based on the third ejection pulse PA3 is secured. Further, the third ejection pulse PA3 and the damping element ED can be regarded as a pull-push-pull waveform, and the effect of residual vibration on the next unit period Tu can be suppressed by increasing the electrical potential change range of the damping element ED.

In addition, as is understood from FIG. 5, the absolute value of the electrical potential change range of the filling element EF3 of the third ejection pulse PA3 that is the last ejection pulse PA among the three ejection pulses PA is greater than the absolute value of the electrical potential change range of the filling element EF1 of the first ejection pulse PA1 that is the first ejection pulse PA among the three ejection pulses PA. Specifically, since the absolute value of the electrical potential change range of the filling element EF3 is V1-VL and the absolute value of the electrical potential change range of the filling element EF1 is V0-VL, the absolute value of the electrical potential change range of the filling element EF3 is greater than the absolute value of the electrical potential change range of the filling element EF1.

As is understood from FIG. 5, the difference between the reference electrical potential V0 and the lowest electrical potential VL is greater than or equal to 50% of the difference between the lowest electrical potential VL and the highest electrical potential VH and less than or equal to 70% of the difference between the lowest electrical potential VL and the highest electrical potential VH. In the example illustrated in FIG. 5, the difference between the reference electrical potential V0 and the lowest electrical potential VL is 60% of the difference between the lowest electrical potential VL and the highest electrical potential VH. The lowest electrical potential VL is the most different from the reference electrical potential V0 among electrical potentials from the lowest electrical potential VL to the highest electrical potential VH in the electrical potential range available for the three ejection pulses PA.

In addition, the period T2_1 of the first coupling element EJ1 that is the first coupling element EJ out of the two coupling elements EJ is set to be greater than or equal to (n1−0.25)×Tc and less than or equal to (n1+0.25)×Tc, and is preferably as close to n1×Tc as possible. Similarly, the period T2_2 of the second coupling element EJ2 that is the last coupling element EJ out of the two coupling elements EJ is set to be greater than or equal to (n1−0.25)×Tc and less than or equal to (n1+0.25)×Tc, and is preferably as close to n1×Tc as possible. In this case, n1 is an integer greater than or equal to 1. Hereinafter, each of the periods T2_1 and T2_2 may be referred to as a period T2. To summarize the above description, each of the periods T2 is set to be greater than or equal to (n1−0.25)×Tc and less than or equal to (n1+0.25)×Tc, and is preferably as close to n1×Tc as possible. In this case, n1 may be the same value or different values in the periods T2 of the two coupling elements EJ. In the example illustrated in FIG. 5, n1 is 1 in the period T2_1, and n1 is 2 in the period T2_2.

The period T2_2 of the second coupling element EJ2 that is the last coupling element EJ out of the two coupling elements EJ is greater than Tc and less than or equal to 2Tc. In the following description, the period T2 of the last coupling element EJ out of the two coupling elements EJ may be referred to as a period T2Last. In the first embodiment, as illustrated in FIG. 5, the period T2_2 is the period T2Last.

Further, the period T2 of the coupling element EJ other than the last coupling element EJ out of the two coupling elements EJ is shorter than the period T2Last of the last coupling element EJ. In particular, the period T2_1 of the first coupling element EJ1 that is the first coupling element EJ is shorter than the period T2_2 of the second coupling element EJ2 that is the last coupling element EJ.

In addition, a time interval T3_1 from the start time TS_{ET1} of the ejection element ET1 of the first ejection pulse PA1 to the start time TS_{ET2} of the ejection element ET2 of the second ejection pulse PA2 is set to be greater than or equal to (n2−0.4)×Tc and less than or equal to n2×Tc. In this case, n2 is an integer greater than or equal to 2. Similarly, a time interval T3_2 from the start time TS_{ET2} to the start time TS_{ET3} of the ejection element ET3 of the third ejection pulse PA3 is set to be greater than or equal to (n2−0.4)×Tc and less than or equal to n2×Tc. Hereinafter, each of the periods T3_1 and T3_2 may be referred to as a period T3. To summarize the above description, each of the time intervals T3 is set to be greater than or equal to (n2−0.4)×Tc and less than or equal to n2×Tc. In this case, n2 may be the same value or different values in the periods T3 of the two coupling elements EJ. In the example illustrated in FIG. 5, n2 is 2 in the period T3_1, and n2 is 3 in the period T3_2.

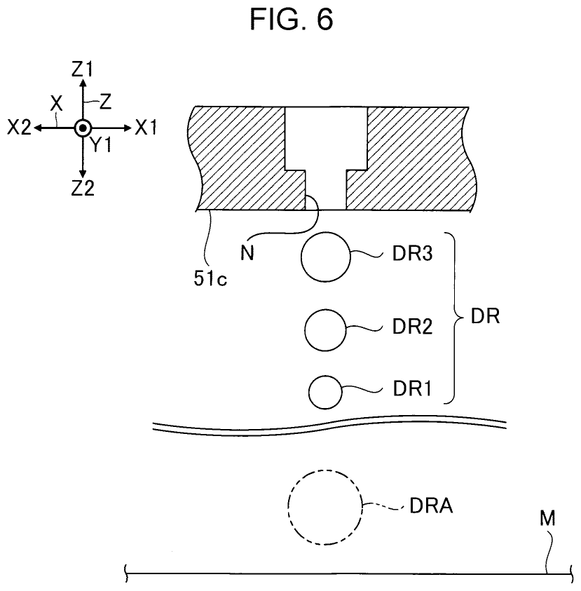

FIG. 6 is a diagram illustrating a coalesced droplet DRA obtained by coalescence of three droplets DR sequentially ejected from the nozzle N. In FIG. 6, as the three droplets DR, a droplet DR1 corresponding to the first ejection pulse PA1, a droplet DR2 corresponding to the second ejection pulse PA2, and a droplet DR3 corresponding to the third ejection pulse

PA3 are indicated by solid lines. Further, in FIG. 6, the coalesced droplet DRA obtained by the coalescence of the droplet DR1, the droplet DR2, and the droplet DR3 is indicated by a two-dot chain line. Aspects such as the positions, sizes, and shapes of the droplet DR1, the droplet DR2, the droplet DR3, and the coalesced droplet DRA are not limited to the example illustrated in FIG. 6.

When the drive signal Com illustrated in FIG. 5 is supplied to the drive element 51f, the droplets DR1, DR2, and DR3 are ejected from the nozzle N in this order as illustrated in FIG. 6. In this case, ejection conditions such as the flying speed and the ejection timing of each of the droplet DR1, the droplet DR2, and the droplet DR3 are set such that the subsequent droplets DR among the droplets DR1, DR2, and DR3 catch up with the preceding droplets DR among the droplets DR1, DR2, and DR3 before landing on the medium M. Accordingly, the coalesced droplet DRA is obtained by the coalescence of the droplet DR1, the droplet DR2, and the droplet DR3.

### A6: Summary of First Embodiment

As described above, the liquid ejecting apparatus 100 according to the first embodiment includes the ejection section D including the nozzle N from which a droplet is ejected to cause the droplet to land on the medium M, the pressure chamber C communicating with the nozzle N, and the drive element 51f that changes pressure applied to the ink in the pressure chamber C when the drive signal CoM is supplied to the drive element 51f, and the drive signal generating circuit 24 that generates the drive signal Com. The drive signal Com includes the three ejection pulses PA, the two coupling elements EJ, and the damping element ED. The three ejection pulses PA correspond to three droplets that coalesce before landing on the medium M, and each of the three ejection pulses PA includes a filling element EF that changes an electrical potential to generate negative pressure in the pressure chamber C, and an ejection element ET that changes the electrical potential to generate positive pressure in the pressure chamber C and eject a droplet from the nozzle N. The two coupling elements EJ couple the consecutive ejection pulses PA among the three ejection pulses PA while maintaining the electrical potential. The damping element ED attenuates residual vibration of the ink in the pressure chamber C by generating negative pressure in the pressure chamber C after the droplets are ejected from the nozzle N after the last ejection pulse PA among the three ejection pulses PA. When the natural vibration period of the ejection section D is Tc, the period T1 from the start of the filling element EF to the start of the ejection element ET in each of the three ejection pulses is set to be greater than or equal to 0.3Tc and less than or equal to 0.7Tc. An absolute value of an electrical potential change range of an ejection element ET of a certain ejection pulse PA among the three ejection pulses PA is greater than an absolute value of an electrical potential change range of an ejection element ET of an ejection pulse PA that is among the three ejection pulses PA and is before the certain ejection pulse PA. One certain coupling element EJ out of the two coupling elements EJ maintains an electrical potential of an ending edge of an ejection element ET of a preceding ejection pulse PA out of two ejection pulses PA coupled to the starting edge and the ending edge of the one coupling element EJ, and is coupled to the starting edge of the filling element EF of the subsequent ejection pulse PA out of the two ejection pulses PA. The electrical potential maintained by the coupling element EJ other than the last coupling element EJ out of the two coupling elements EJ is between the electrical potential of the ending edge of the filling element EF of the first ejection pulse PA among the three ejection pulses PA and the electrical potential maintained by the coupling element EJ that is after the coupling element EJ other than the last coupling element EJ. In the first embodiment, the electrical potential of the ending edge of each of the filling elements EF is the lowest electrical potential VL, in other words, the electrical potential maintained by the coupling element EJ other than the last coupling element EJ is lower than the electrical potential maintained by the coupling element EJ that is after the coupling element EJ other than the last coupling element EJ.

As an electrical potential before and after a change to the lowest electrical potential VL is more different from the lowest electrical potential VL, absolute values of electrical potential change ranges before and after the change can be increased. Therefore, according to the first embodiment, since the electrical potential maintained by the subsequent coupling element EJ out of the two coupling elements EJ is higher than the electrical potential maintained by the preceding coupling element EJ out of the two coupling elements EJ, it is possible to easily increase the electrical potential change ranges of the filling element EF and the ejection element ET of the ejection pulse PA coupled to the subsequent coupling element EJ, as compared to an aspect in which the electrical potentials maintained by the two coupling elements EJ are the same. In addition, since the electrical potential maintained by the subsequent coupling element EJ is higher than the electrical potential maintained by the preceding coupling element EJ, the absolute value of the electrical potential change range of the damping element ED can also be increased and thus the residual vibration can be sufficiently attenuated by the damping element ED. Therefore, in the present embodiment, as compared to a case where so-called two-stage damping is performed in which the electrical potential of the ending edge of the damping element ED is changed to be lower than the reference electrical potential V0 and then increased to the reference electrical potential V0, the period required to sufficiently attenuate the residual vibration can be shortened, and it is not necessary to lengthen the unit period Tu. As described above, according to the embodiment, since it is not necessary to lengthen the unit period Tu while securing the amount of droplets by easily increasing the electrical potential change ranges of the filling elements EF and the ejection elements ET of the ejection pulses PA, it is easy to cause the droplets to coalesce by the time the droplets reach a desired position.

In addition, since the periods T1 are set to be greater than or equal to 0.3Tc and less than or equal to 0.7Tc, it is possible to push out the meniscus in the ejection direction by efficiently using a change in the pressure when the meniscus start to be drawn in the direction opposite to the ejection direction, as compared to an aspect in which the periods T1 are less than 0.3Tc or greater than 0.7Tc.

In addition, since the first ejection pulse PA1 and the second ejection pulse PA2 do not include the damping element ED, it is possible to make the coupling elements EJ longer, as compared to an aspect in which the first ejection pulse PA1 and the second ejection pulse PA2 include the damping element ED. By increasing the lengths of the coupling elements EJ, it is possible to suppress instability of ejection that occurs due to a variation in dimensions of the flow path of the ejection section D or the like. The instability of the ejection indicates that, for example, a direction in which a droplet is ejected deviates from the predetermined direction, a droplet is not ejected from the nozzle N, and the amounts of droplets vary.

In addition, in the first ejection pulse PA1, the electrical potential of the ending edge of the ejection element ET1 is equal to the electrical potential of the starting edge of the filling element EF1. In each of the second and subsequent ejection pulses PA among the three ejection pulses PA, the absolute value of the electrical potential change range of the ejection element ET is greater than the absolute value of the electrical potential change range of the filling element EF. In other words, in the present embodiment, in each of the second and subsequent ejection pulses PA, the electrical potential of the ending edge of the ejection element ET is higher than the electrical potential of the starting edge of the filling element EF.

Since the electrical potential of the ending edge of the ejection element ET1 is equal to the electrical potential of the starting edge of the filling element EF1 in the first ejection pulse PA1, the speed of a droplet ejected based on the first ejection pulse PA1 can be reduced, as compared to an aspect in which the electrical potential of the ending edge of the ejection element ET1 is higher than the electrical potential of the starting edge of the filling element EF1. In addition, since the electrical potential of the ending edge of the ejection element ET is higher than the electrical potential of the starting edge of the filling element EF in each of the second and subsequent ejection pulses PA, the absolute value of the electrical potential change range of the ejection element ET in each of the second and subsequent ejection pulses PA can be increased, and the speed of a droplet ejected based on each of the second and subsequent ejection pulses PA can be increased. As described above, according to the first embodiment, by decreasing the speed of a preceding droplet and increasing the speed of a subsequent droplet, it is easy to cause three droplets to coalesce.

In addition, the absolute value of the electrical potential change range of the filling elements EF3 of the third ejection pulse PA3 is greater than the absolute value of the electrical potential change range of the filling element EF1 of the first ejection pulse PA1.

Since the absolute value of the electrical potential change range of the filling element EF3 is greater than the absolute value of the electrical potential change range of the filling element EF1, the residual vibration of the ink in the pressure chamber C when the ejection element ET3 is supplied to the drive element 51f is greater than the residual vibration of the ink in the pressure chamber C when the ejection element ET1 is supplied to the drive element 51f. Therefore, it is possible to increase the speed of a droplet ejected based on the third ejection pulse PA3 and reduce the speed of a droplet ejected based on the first ejection pulse PA1. In addition, as compared to an aspect in which the absolute value of the electrical potential change range of the filling element EF3 is less than the absolute value of the electrical potential change range of the filling element EF1, the speed of a droplet ejected based on the first ejection pulse PA1 can be lower than the speed of a droplet ejected based on the third ejection pulse PA3. Therefore, according to the first embodiment, since the speed of a preceding droplet is lower than the speed of a subsequent droplet, it is easy to cause three droplets to coalesce.

In addition, the difference between the reference electrical potential V0 of the drive signal Com and the lowest electrical potential VL that is the most different from the reference electrical potential V0 among electrical potentials in the electrical potential range available for the three ejection pulses PA is greater than or equal to 50% of the difference between the lowest electrical potential VL and the highest electrical potential VH in the electrical potential range available for the three ejection pulses PA and is less than or equal to 70% of the difference between the lowest electrical potential VL and the highest electrical potential VH in the electrical potential range available for the three ejection pulses PA.

If the difference between the reference electrical potential V0 and the lowest electrical potential VL is less than 50% of the difference between the lowest electrical potential VL and the highest electrical potential VH in the electrical potential range available for the three ejection pulses PA, the absolute values of the electrical potential change ranges of the filling element EF1 and the ejection element ET1 of the first ejection pulse PA1 are small, and thus it is difficult to secure the amounts of droplets. On the other hand, if the difference between the reference electrical potential V0 and the lowest electrical potential VL is higher than 70% of the difference between the lowest electrical potential VL and the highest electrical potential VH in the electrical potential range available for the three ejection pulses PA, since the absolute value of the electrical potential change range of the damping element ED is small, the above-described two-stage damping is required, and it is necessary to lengthen the unit period Tu. As described above, according to the first embodiment, since the absolute values of the electrical potential change ranges of the filling element EF1 and the ejection element ET1 can be increased, it is not necessary to increase the unit period Tu while securing the amounts of droplets, and thus it is easy to cause droplets to coalesce by the time the droplets reach a desired position.

Further, each of the periods T2 of the two coupling elements EJ is set to be greater than or equal to (n1−0.25)×Tc and less than or equal to (n1+0.25)×Tc, where n1 is an integer greater or equal to 1.

After the ink is ejected, the ink in the ejection section D vibrates according to the natural vibration period Tc of the ejection section D. When the period T2 approaches an integral multiple of Tc, even if the ejection pulse PA does not include the damping element ED, the speed of a droplet can be increased by effectively using the residual vibration. As described above, according to the first embodiment, by increasing the speed of a droplet, the droplet can be stably ejected.

The period T2Last of the last coupling element EJ out of the two coupling elements EJ is greater than Tc and less than or equal to 2Tc.

Since the period T2Last is greater than Tc, and the last ejection pulse PA is supplied after the vibration of the meniscus is attenuated to some extent, it is possible to stabilize the ejection based on the last ejection pulse PA having a high ejection ability and to suppress the generation of a satellite droplet. The satellite droplet is a fine droplet separated from a droplet when the droplet is ejected. If the satellite droplet lands on the medium M, the quality of an image formed on the medium M is reduced. In addition, since the period T2Last is less than or equal to 2Tc, it is easy to cause droplets to coalesce by the time the droplets reach a desired position, as compared to an aspect in which the period T2Last is greater than 2Tc.

Further, the period T2 of the coupling element EJ other than the last coupling element EJ out of the two coupling elements EJ is shorter than the period T2Last of the last coupling element EJ.

In an aspect in which a plurality of droplets coalesce, before a satellite droplet separated from a preceding droplet lands on the medium M, a subsequent droplet coalesces with the satellite droplet so as to collect the satellite droplet. A satellite droplet separated from a droplet other than the last droplet can be collected before landing on the medium M, but a satellite droplet separated from the last droplet cannot be collected before landing on the medium M. Therefore, in the present embodiment, the period T2Last of the last coupling element EJ can be adjusted to be longer than the period T2 of the coupling element EJ other than the last coupling element EJ such that the last ejection pulse PA is supplied at a timing at which the separation of a satellite droplet from the last droplet ejected based on the last ejection pulse PA can be suppressed.

In addition, a time interval T3 between the start of the ejection element ET of one of two consecutive ejection pulses PA among the three ejection pulses PA and the start of the ejection element ET of the other of the two consecutive ejection pulses PA is set to be greater than or equal to (n2−0.4)×Tc and less than or equal to n2×Tc, where n2 is an integer greater than or equal to 2.

The time interval T3 is synonymous with a time interval between the start of one of the two ejection pulses PA and the start of the other of the two ejection pulses PA. When the time interval T3 approaches an integer multiple of Tc, the speed of a droplet ejected based on the subsequent ejection pulse PA can be increased by efficiently using the residual vibration caused by the preceding ejection pulse PA even when the ejection pulses PA other than the last ejection pulse PA do not include the damping element ED, and therefore the liquid ejecting apparatus 100 can stably eject droplets.

### B: Modifications

Each of the above-described embodiments can be variously modified. Specific modifications that can be applied to each of the above-described embodiments will be described below. Two or more aspects freely selected from the following examples can be appropriately combined within a range in which the two or more aspects do not contradict each other.

### B1: First Modification

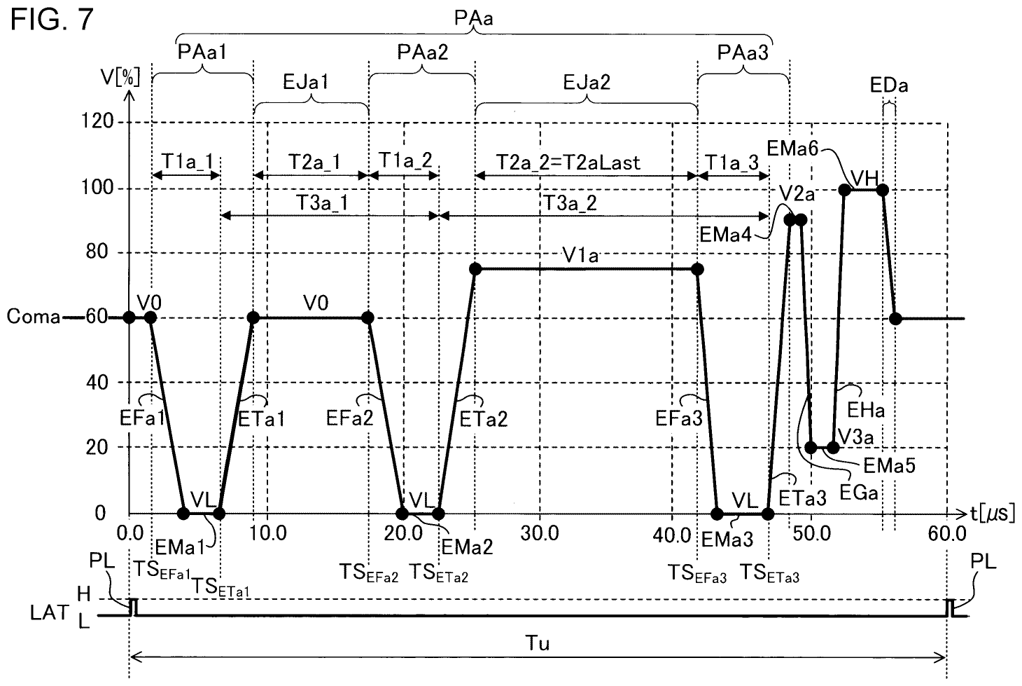

FIG. 7 is a diagram illustrating a drive signal Coma in a first modification. The drive signal Coma is different from the drive signal Com in that the drive signal Coma includes three ejection pulses PAa instead of the three ejection pulses PA, includes two coupling elements EJa instead of the two coupling elements EJ, and includes a damping element EDa instead of the damping element ED. The three ejection pulses PAa are different from the three ejection pulses PA in that the three ejection pulses PAa include a first ejection pulse PAa1 instead of the first ejection pulse PA1, include a second ejection pulse PAa2 instead of the second ejection pulse PA2, and include a third ejection pulse PAa3 instead of the third ejection pulse PA3. The two coupling elements EJa are different from the two coupling elements EJ in that the two coupling elements EJa include a first coupling element EJa1 instead of the first coupling element EJ1, and include a second coupling element EJa2 instead of the second coupling element EJ2.

The first ejection pulse PAa1, the second ejection pulse PAa2, and the third ejection pulse PAa3 are three ejection pulses PAa for sequentially ejecting, from the nozzle N, three droplets that coalesce after being ejected from the nozzle N and before landing on the medium M. The three ejection pulses PAa are aligned in time corresponding to the three droplets. Since the mode of coupling the three ejection pulses PAa and the two coupling elements EJa is the same as the mode of coupling the three ejection pulses PA and the two coupling elements EJ, the description thereof will be omitted.

The first ejection pulse PAa1 is different from the first ejection pulse PA1 in that the first ejection pulse PAa1 includes a filling element EFa1 instead of the filling element EF1, includes an electrical potential maintained element EMa1 instead of the electrical potential maintained element EM1, and includes an ejection element ETa1 instead of the ejection element ET1. However, the shape of the first ejection pulse PAa1 is substantially the same as the shape of the first ejection pulse PA1.

The second ejection pulse PAa2 is different from the second ejection pulse PA2 in that the second ejection pulse PAa2 includes a filling element EFa2 instead of the filling element EF2, includes an electrical potential maintained element EMa2 instead of the electrical potential maintained element EM2, and includes an ejection element ETa2 instead of the ejection element ET2. The ejection element ETa2 is different from the ejection element ET2 in that the ejection element ETa2 changes from the lowest electrical potential VL to an electrical potential V1a. The electrical potential V1a is between the reference electrical potential V0 and the electrical potential V1. Specifically, the electrical potential V1a is an electrical potential of about 74%. The second coupling element EJa2 maintains the electrical potential V1a.

The third ejection pulse PAa3 is different from the third ejection pulse PA3 in that the third ejection pulse PAa3 includes a filling element EFa3 instead of the filling element EF3, includes an electrical potential maintained element EMa3 instead of the electrical potential maintained element EM3, and includes an ejection element ETa3 instead of the ejection element ET3. Further, the third ejection pulse PAa3 is different from the third ejection pulse PA3 in that the third ejection pulse PAa3 is coupled to the damping element EDa via an electrical potential maintained element EMa4, a damping expansion element EGa, an electrical potential maintained element EMa5, a damping contraction element EHa, and an electrical potential maintained element EMa6. Furthermore, the amount of a droplet ejected based on the third ejection pulse PAa3 is less than the amount of a droplet ejected based on the third ejection pulse PA3.

Hereinafter, each of the filling elements EFa1, EFa2, and EFa3 may be referred to as a filling element EFa. Each of the ejection elements ETa1, ETa2, and ETa3 may be referred to as an ejection element ETa.

The ejection element ETa3 is coupled to the electrical potential maintained element EMa4 by changing from the lowest electrical potential VL to an electrical potential V2a. The electrical potential V2a is between the electrical potential V1a and the highest electrical potential VH. Specifically, the electrical potential V2a is an electrical potential of about 90%. The electrical potential maintained element EMa4 maintains the electrical potential V2a and is coupled to the damping expansion element EGa at the ending edge of the electrical potential maintained element EMa4. The damping expansion element EGa changes from the electrical potential V2a to an electrical potential V3a to expand the pressure chamber C, and is coupled to the electrical potential maintained element EMa5 at the ending edge of the damping expansion element EGa. The electrical potential V3a is between the reference electrical potential V0 and the lowest electrical potential VL. Specifically, the electrical potential V3a is an electrical potential of about 20%. The electrical potential maintained element EMa5 maintains the electrical potential V3a, and is coupled to the damping contraction element EHa at the ending edge of the electrical potential maintained element EMa5. The damping contraction element EHa changes from the electrical potential V3a to the highest electrical potential VH to contract the pressure chamber C, and is coupled to the electrical potential maintained element EMa6 at the ending edge of the damping contraction element EHa. The electrical potential maintained element EMa6 maintains the highest electrical potential VH and is coupled to the damping element EDa at the ending edge of the electrical potential maintained element EMa6.

As in the first embodiment, a period T1a_1 from the start time TS_{EFa1} of the filling element EFa1 of the first ejection pulse PAa1 to the start time TS_{ETa1} of the ejection element ETa1 of the first ejection pulse PAa1 is set to be greater than or equal to 0.3Tc and less than or equal to 0.7Tc, and is preferably as close to 0.5Tc as possible. Similarly, a period T1a_2 from the start time TS_{EFa2} of the filling element EFa2 of the second ejection pulse PAa2 to the start time TS_{ETa2} of the ejection element ETa2 of the second ejection pulse PAa2 is set to be greater than or equal to 0.3Tc and less than or equal to 0.7Tc, and is preferably as close to 0.5Tc as possible. In addition, a period T1a_3 from the start time TS_{EFa3} of the filling element EFa3 of the third ejection pulse PAa3 to the start time TS_{ETa3} of the ejection element ETa3 of the third ejection pulse PAa3 is set to be greater than or equal to 0.3 TC and less than or equal to 0.7Tc, and is preferably as close to 0.5Tc as possible.

In addition, an absolute value of an electrical potential change range of an ejection element ETa of a certain ejection pulse PAa among the ejection pulses PAa is greater as the certain ejection pulse PAa is supplied later. Specifically, the absolute value of the electrical potential change range of the ejection element ETa1 is V0-VL, the absolute value of the electrical potential change range of the ejection element ETa2 is V1a-VL, and V1a is higher than V0. Therefore, the absolute value of the electrical potential change range of the ejection element ETa2 is greater than the absolute value of the electrical potential change range of the ejection element ETa1. Further, the absolute value of the electrical potential change range of the ejection element ETa3 are V2a-VL, and V2a is higher than V1a. Therefore, the absolute value of the electrical potential change range of the ejection element ETa3 is greater than the absolute value of the electrical potential change range of the ejection element ETa2.

In addition, the reference electrical potential V0 that is the electrical potential maintained by the first coupling element EJa1 is between the lowest electrical potential VL that is the electrical potential of the ending edge of the filling element EFa1 of the first ejection pulse PAa1 that is the first ejection pulse PAa among the three ejection pulses PAa and the electrical potential V1a maintained by the second coupling element EJa2 that is after the first coupling element EJa1.

In addition, as in the first embodiment, the reference electrical potential V0 that is the electrical potential of the ending edge of the ejection element ETa1 of the first ejection pulse PAa1 that is the first ejection pulse PAa among the three ejection pulses PAa is equal to the reference electrical potential V0 that is the electrical potential of the starting edge of the filling element EFa1. In addition, in each of the second and subsequent ejection pulses PAa among the three ejection pulses PAa, the absolute value of the electrical potential change range of the ejection element ETa is greater than the absolute value of the electrical potential change range of the filling element EFa. Specifically, the absolute value of the electrical potential change range of the ejection element ETa2 of the second ejection pulse PAa2 is V1a-VL, and the absolute value of the electrical potential change range of the filling element EFa2 is V0-VL. Therefore, the absolute value of the electrical potential change range of the ejection element ETa2 is greater than the absolute value of the electrical potential change range of the filling element EFa2. Similarly, the absolute value of the electrical potential change range of the ejection element ETa3 of the third ejection pulse PAa3 is V2a-VL, the absolute value of the electrical potential change range of the filling element EFa3 is V1a-VL, and V2a is higher than V1a. Therefore, the absolute value of the electrical potential change range of the ejection element ETa3 is greater than the absolute value of the electrical potential change range of the filling element EFa3.

In addition, as in the first embodiment, the absolute value of the electrical potential change range of the filling element EFa3 of the third ejection pulse PAa3 that is the last ejection pulse PAa among the three ejection pulses PAa is greater than the absolute value of the electrical potential change range of the filling element EFa1 of the first ejection pulse PAa1 that is the first ejection pulse PAa among the three ejection pulses PAa. Specifically, since the absolute value of the electrical potential change range of the filling element EFa3 is V1a-VL, and the absolute value of the electrical potential change range of the filling element EFa1 is V0-VL, the absolute value of the electrical potential change range of the filling element EFa3 is greater than the absolute value of the electrical potential change range of the filling element EFa1.

Further, the period T2a_1 of the first coupling element EJa1 that is the first coupling element EJa out of the two coupling elements EJa is set to be greater than or equal to (n1−0.25)×Tc and less than or equal to (n1+0.25)×Tc, and is preferably as close to n1×Tc as possible. Similarly, the period T2a_2 of the second coupling element EJa2 that is the last coupling element EJa out of the two coupling elements EJa is set to be greater than or equal to (n1−0.25)×Tc and less than or equal to (n1+0.25)×Tc, and is preferably as close to n1×Tc as possible. Hereinafter, each of the periods T2a_1 and T2a_2 may be referred to as a period T2a.

The period T2a_2 of the second coupling element EJa2 that is the last coupling element EJa out of the two coupling elements EJa is greater than Tc and less than or equal to 2Tc. In the following description, the period T2a of the last coupling element EJa out of the two coupling elements EJa may be referred to as a period T2aLast. In the first modification, as illustrated in FIG. 7, the period T2a_2 is the period T2aLast.

Further, the period T2a of the coupling element EJa other than the last coupling element EJa out of the two coupling elements EJa is shorter than the period T2aLast of the last coupling element EJa. In particular, the period T2a_1 of the first coupling element EJa1 that is the first coupling element EJa is shorter than the period T2a_2 of the second coupling element EJa2 that is the last coupling element EJa.

In addition, a time interval T3a_1 from the start time TS_{ETa1} of the ejection element ETa1 of the first ejection pulse PAa1 to the start time TS_{ETa2} of the ejection element ETa2 of the second ejection pulse PAa2 is set to be greater than or equal to (n2−0.4)×Tc and less than or equal to n2×Tc. Similarly, a time interval T3a_2 from the start time TS_{ETa2} to the start time TS_{ETa3} of the ejection element ETa3 of the third ejection pulse PAa3 is set to be greater than or equal to (n2−0.4)×Tc and less than or equal to n2×Tc.

### B2: Second Modification

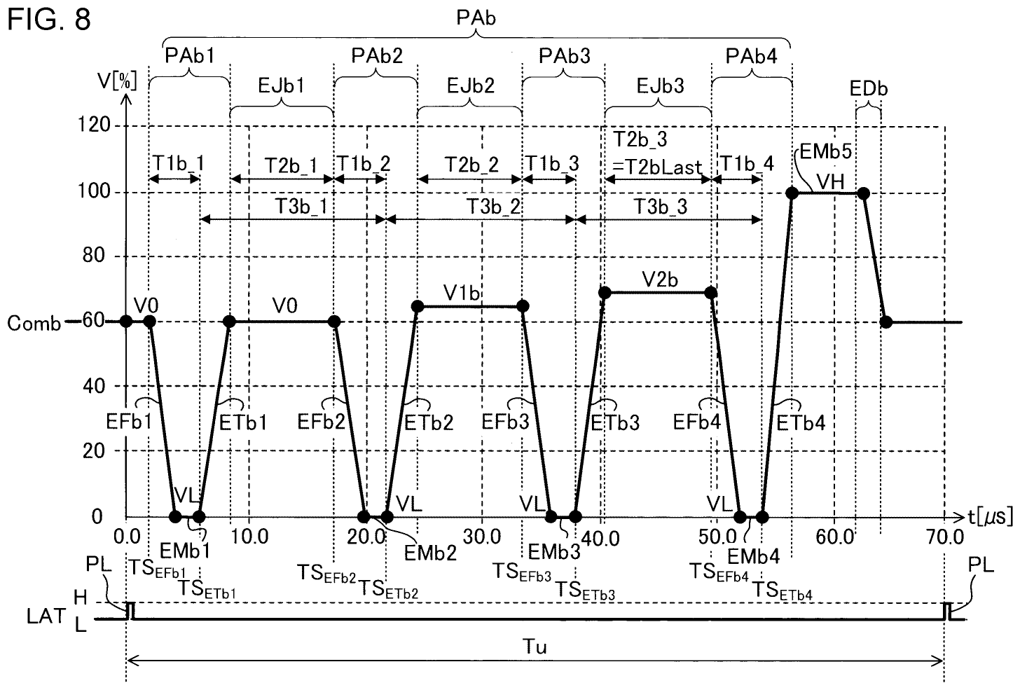

FIG. 8 is a diagram illustrating a drive signal Comb in a second modification. The drive signal Comb is different from the drive signal Com in that the drive signal Comb includes four ejection pulses PAb instead of the three ejection pulses PA, includes three coupling elements EJb instead of the two coupling elements EJ, and includes a damping element EDb instead of the damping element ED. The four ejection pulses PAb are different from the three ejection pulses PA in that the four ejection pulses PAb include a first ejection pulse PAb1 instead of the first ejection pulse PA1, include a second ejection pulse PAb2 instead of the second ejection pulse PA2, include a third ejection pulse PAb3 instead of the third ejection pulse PA3, and further include a fourth ejection pulse PAb4. The three coupling elements EJb are different from the two coupling elements EJ in that the three coupling elements Ejb include a first coupling element EJb1 instead of the first coupling elements EJ1, include a second coupling element EJb2 instead of the second coupling element EJ2, and further include a third coupling element EJb3. The four ejection pulses PAb are an example of the “at least three ejection pulses”. The three coupling elements EJb are an example of the “at least two coupling elements”.

The first ejection pulse PAb1, the second ejection pulse PAb2, the third ejection pulse PAb3, and the fourth ejection pulse PAb4 are the four ejection pulses PAb for sequentially ejecting, from the nozzle N, four droplets that coalesce after being ejected from the nozzle N and before landing on the medium M. The fourth ejection pulses PAb4 are aligned in time corresponding to the four droplets. Since the mode of coupling the three ejection pulses PAb other than the last ejection pulse PAb among the four ejection pulses PAb and the two coupling elements EJb other than the last coupling element EJb among the three coupling elements EJb is the same as the mode of coupling the three ejection pulses PA and the two coupling elements EJ, and thus the description thereof will be omitted.

The first ejection pulse PAb1 is different from the first ejection pulse PA1 in that the first ejection pulse PAb1 includes a filling element EFb1 instead of the filling element EF1, includes an electrical potential maintained element EMb1 instead of the electrical potential maintained element EM1, and includes an ejection element ETb1 instead of the ejection element ET1. However, the shape of the first ejection pulse PA1b is substantially the same as the shape of the first ejection pulse PA1.

The second ejection pulse PAb2 is different from the second ejection pulse PA2 in that the second ejection pulse PAb2 includes a filling element EFb2 instead of the filling element EF2, includes an electrical potential maintained element EMb2 instead of the electrical potential maintained element EM2, and includes an ejection element ETb2 instead of the ejection element ET2. The ejection element ETb2 is different from the ejection element ET2 in that the ejection element ETb2 changes from the lowest electrical potential VL to an electrical potential V1b. The electrical potential V1b is between the reference electrical potential V0 and the electrical potential V1. Specifically, the electrical potential V1b is an electrical potential of about 65%. The second coupling element EJb2 maintains the electrical potential V1b.

The third ejection pulse PAb3 is different from the third ejection pulse PA3 in that the third ejection pulse PAb3 includes a filling element EFb3 instead of the filling element EF3, includes an electrical potential maintained element EMb3 instead of the electrical potential maintained element EM3, and includes an ejection element ETb3 instead of the ejection element ET3. The filling element EFb3 is different from the filling element EF3 in that the filling element EFb3 changes from the electrical potential V1b to the lowest electrical potential VL. The ejection element ETb3 is different from the ejection element ET3 in that the ejection element ETb3 changes from the lowest electrical potential VL to an electrical potential V2b. The electrical potential V2b is between the electrical potential V1b and the highest electrical potential VH. Specifically, the electrical potential V2b is an electrical potential of about 70%.

The third ejection pulse PAb3 is coupled to the fourth ejection pulse PAb4 via the third coupling element EJb3. In the example illustrated in FIG. 8, the starting edge of the third coupling element EJb3 is coupled to the ending edge of the ejection element ETb3 of the third ejection pulse PAb3. The third coupling element EJb3 maintains the electrical potential V2b.

The fourth ejection pulse PAb4 is the last ejection pulse PA among the four ejection pulses PA in the unit period Tu. In the example illustrated in FIG. 8, the fourth ejection pulse PAb4 includes a filling element EFb4 and an ejection element ETb4 in this order. The filling element EFb4 and the ejection element ETb4 are coupled to each other via an electrical potential maintained element EMb4 that maintains the lowest electrical potential VL. The filling element EFb4 changes from the electrical potential V2b to the lowest electrical potential VL. The ejection element ETb4 is coupled to an electrical potential maintained element EMb5 by changing from the lowest electrical potential VL to the highest electrical potential VH.

As described above, the fourth ejection pulse PAb4 is an electrical potential pulse having a waveform in which the electrical potential changes from the electrical potential V2b to the lowest electrical potential VL to the highest electrical potential VH. When the fourth ejection pulse PAb4 is supplied to the drive element 51f, the drive element 51f generates negative pressure in the pressure chamber C based on the filling element EFb4, and then generates positive pressure in the pressure chamber C based on the ejection element ETb4 so as to cause a droplet to be ejected from the nozzle N.

The fourth ejection pulse PAb4 is coupled to the damping element EDb via the electrical potential maintained element EMb5. In the example illustrated in FIG. 8, the starting edge of the electrical potential maintained element EMb5 is coupled to the ending edge of the ejection element ETb4 of the fourth ejection pulse PAb4. The electrical potential maintained element EMb5 maintains the highest electrical potential VH.

Hereinafter, each of the filling elements EFb1, EFb2, EFb3, and EFb4 may be referred to as a filling element EFb. Each of the ejection elements ETb1, ETb2, ETb3, and ETb4 may be referred to as an ejection element ETb.

As in the first embodiment, a period T1b_1 from the start time TS_{EFb1} of the filling element EFb1 of the first ejection pulse PAb1 to the start time TS_{ETb1} of the ejection element ETb1 of the first ejection pulse PAb1 is set to be greater than or equal to 0.3Tc and less than or equal to 0.7Tc, and is preferably as close to 0.5Tc as possible. Similarly, a period T1b_2 from the start time TS_{EFb2} of the filling element EFb2 of the ejection pulse PAb2 to the start time TS_{ETb2} of the ejection element ETb2 of the second ejection pulse PAb2 is set to be greater than or equal to 0.3Tc and less than or equal to 0.7Tc, and is preferably as close to 0.5Tc as possible. In addition, a period T1b_3 from the start time TS_{EFb3} of the filling element EFb3 of the third ejection pulse PAb3 to the start time TS_{ETb3} of the ejection element ETb3 of the third ejection pulse PAb3 is set to be greater than or equal to 0.3Tc and less than or equal to 0.7Tc, and is preferably as close to 0.5Tc as possible. Further, a period T1b_4 from the start time TS_{EFb4} of the filling element EFb4 of the fourth ejection pulse PAb4 to the start time TS_{ETb4} of the ejection element ETb4 of the fourth ejection pulse PAb4 is set to be greater than or equal to 0.3Tc and less than or equal to 0.7Tc, and is preferably as close to 0.5Tc as possible.

In addition, an absolute value of an electrical potential change range of an ejection element ETb of a certain ejection pulse PAb among the ejection pulses PAb is greater as the certain ejection pulse PAa is supplied later. Specifically, the absolute value of the electrical potential change range of the ejection element ETb1 is V0-VL, the absolute value of the electrical potential change range of the ejection element ETb2 is and V1b-VL, and V1b is higher than V0. Therefore, the absolute value of the electrical potential change range of the ejection element ETb2 is greater than the absolute value of the electrical potential change range of the ejection element ETb1. Further, the absolute value of the electrical potential change range of the ejection element ETb3 is V2b-VL, and V2b is higher than V1b. Therefore, the absolute value of the electrical potential change range of the ejection element ETb3 is greater than the absolute value of the electrical potential change range of the ejection element ETb2. The absolute value of the electrical potential change range of the ejection element ETb4 is VH-VL, and VH is higher than V2b. Therefore, the absolute value of the electrical potential change range of the ejection element ETb4 is greater than the absolute value of the electrical potential change range of the ejection element ETb3. In the second modification, when the fourth ejection pulse PAb4 corresponds to an “ejection pulse that is among the at least three ejection pulses and is not a first ejection pulse among the at least three ejection pulses”, each of the first ejection pulse PAb1, the second ejection pulse PAb2, and the third ejection pulse PAb3 corresponds to an “ejection pulse that is among the at least three ejection pulses and is before the ejection pulse that is among the at least three ejection pulses and is not the first ejection pulse”.

In addition, the reference electrical potential V0 that is the electrical potential maintained by the first coupling element EJb1 is between the lowest electrical potential VL that is the electrical potential of the ending edge of the filling element EFb1 of the first ejection pulse PAb1 that is the first ejection pulse PAb among the four ejection pulses PAb and the electrical potential V1b maintained by the second coupling element EJb2 that is after the first coupling element EJb1. Further, the reference electrical potential V0 is between the lowest electrical potential VL that is the electrical potential of the ending edge of the filling element EFb1 and the electrical potential V2b maintained by the third coupling element EJb3 that is after the first coupling element EJb1. In the second modification, when the first coupling element EJb1 corresponds to a “coupling element that is among the at least two coupling elements and is not a last coupling element among the at least two coupling elements”, each of the second coupling element EJb2 and the third coupling element EJb3 corresponds to a “coupling element that is among the at least two coupling elements and is after a coupling element that is among the at least two coupling elements and is not the last coupling element”. When the second coupling element EJb2 corresponds to a “coupling element that is among the at least two coupling elements and is not a last coupling element among the at least two coupling elements”, the third coupling element EJb3 corresponds to a “coupling element that is among the at least two coupling elements and is after a coupling element that is among the at least two coupling elements and is not the last coupling element”.

In addition, as in the first embodiment, the reference electrical potential V0 that is the electrical potential of the termination end of the ejection element ETb1 of the first ejection pulse PAb1 that is the first ejection pulse PAb among the four ejection pulses PAb is equal to the reference electrical potential V0 that is the electrical potential of the starting edge of the filling element EFb1. Further, in each of the second and subsequent ejection pulses PAb among the four ejection pulses PAb, the absolute value of the electrical potential change range of the ejection element ETb is greater than the absolute value of the electrical potential change range of the filling element EFb. Specifically, the absolute value of the electrical potential change range of the ejection element ETb2 of the second ejection pulse PAb2 is V1b-VL, and the absolute value of the electrical potential change range of the filling element EFb2 is V0-VL. Therefore, the absolute value of the electrical potential change range of the ejection element ETb2 is greater than the absolute value of the electrical potential change range of the filling element EFb2. In addition, the absolute value of the electrical potential change range of the ejection element ETb3 of the third ejection pulse PAb3 is V2b-VL, the absolute value of the electrical potential change range of the filling element EFb3 is V1b-VL, and V2b is higher than V1b. Therefore, the absolute value of the electrical potential change range of the ejection element ETb3 is greater than the absolute value of the electrical potential change range of the filling element EFb3. Further, the absolute value of the electrical potential change range of the ejection element ETb4 of the fourth ejection pulse PAb4 is VH-VL, and the absolute value of the electrical potential change range of the filling element EFb4 is V2b-VL, where VH is higher than V2b. Therefore, the absolute value of the electrical potential change range of the ejection element ETb4 is greater than the absolute value of the electrical potential change range of the filling element EFb4.

In addition, as in the first embodiment, the absolute value of the electrical potential change range of the filling element EFb4 of the fourth ejection pulse PAb4 that is the last ejection pulse PAb among the four ejection pulses PAb is greater than the absolute value of the electrical potential change range of the filling element EFb1 of the first ejection pulse PAb1 that is the first ejection pulse PAb among the four ejection pulses PAb. Specifically, since the absolute value of the electrical potential change range of the filling element EFb4 is V2b-VL and the absolute value of the electrical potential change range of the filling element EFb1 is V0-VL, the absolute value of the electrical potential change range of the filling element EFb4 is greater than the absolute value of the electrical potential change range of the filling element EFb1.

Further, the period T2b_1 of the first coupling element EJb1 that is the first coupling element EJb among the three coupling elements EJb is set to be greater than or equal to (n1−0.25)×Tc and less than or equal to (n1+0.25)×Tc, and is preferably as close to n1×Tc as possible. Similarly, the period T2b_2 of the second coupling element EJb2 that is the second coupling element EJb among the three coupling elements EJb is set to be greater than or equal to (n1−0.25)×Tc and less than or equal to (n1+0.25)×Tc, and is preferably as close to n1×Tc as possible. Further, the period T2b_3 of the third coupling element EJb3 that is the last coupling element EJb among the three coupling elements EJb is set be greater than or equal to (n1−0.25)×Tc and less than or equal to (n1+0.25)×Tc, and is preferably as close to n1×Tc as possible. Hereinafter, each of the periods T2b_1, T2b_2, and T2b_3 may be referred to as a period T2b.

The period T2b_3 of the third coupling element EJb3 that is the last coupling element EJb among the three coupling elements EJb is greater than Tc and less than or equal to 2Tc. In the following description, the period T2b of the last coupling element EJb among the three coupling elements EJb may be referred to as a period T2bLast. In the second modified example, as illustrated in FIG. 8, the period T2b_3 is the period T2bLast.

Further, the periods T2b of the coupling elements EJb other than the last coupling element EJb among the three coupling elements EJb are shorter than the period T2bLast of the last coupling element EJb. More specifically, the period T2b_1 of the first coupling element EJb1 that is the first coupling element EJb and the period T2b_2 of the second coupling element EJb2 that is the second coupling element EJb are shorter than the period T2b_3 of the third coupling element EJb3 that is the last coupling element EJb.

In addition, a time interval T3b_1 from the start time TS_{ETb1} of the ejection element ETb1 of the first ejection pulse PAb1 to the start time TS_{ETb2} of the ejection element ETb2 of the second ejection pulse PAb2 is set to be greater than or equal to (n2−0.4)×Tc and less than or equal to n2×Tc. Similarly, a time interval T3b_2 from the start time TS_{ETb2} to the start time TS_{ETb3} of the ejection element ETb3 of the third ejection pulse PAb3 is set to be greater than or equal to (n2−0.4)×Tc and less than or equal to n2×Tc. In addition, a time interval T3b_3 from the start time TS_{ETb3} to the start time TS_{ETb4} of the ejection element ETb4 of the fourth ejection pulse PAb4 is set to be greater than or equal to (n2−0.4)×Tc and less than or equal to n2×Tc.

### B3: Third Modification

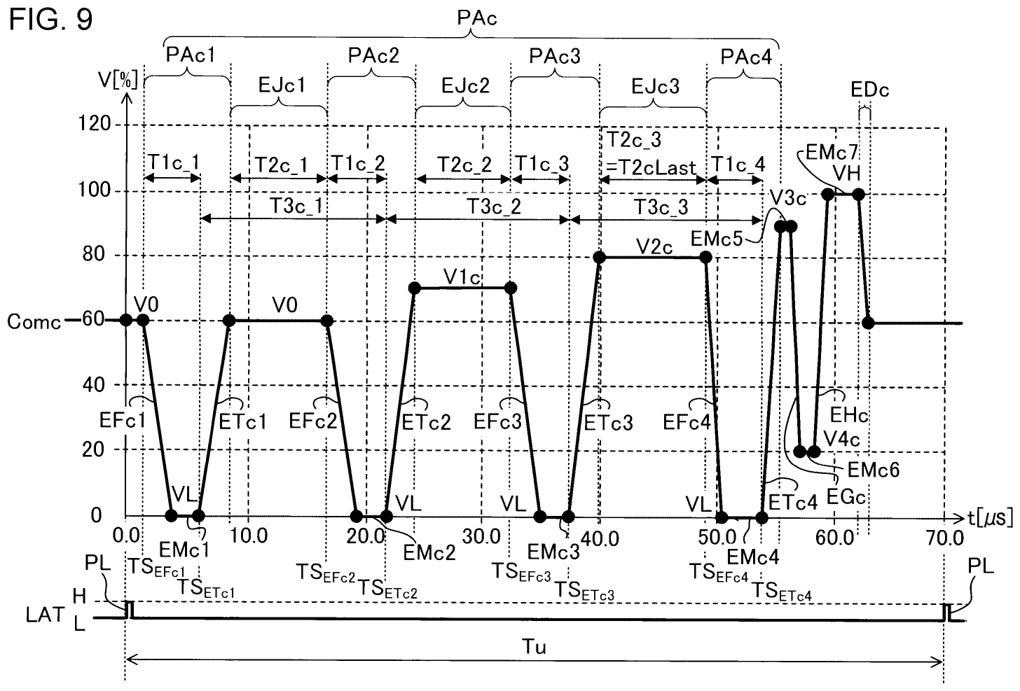

FIG. 9 is a diagram illustrating a drive signal Comc in a third modification. The drive signal Comc is different from the drive signal Comb in that the drive signal Comc includes four ejection pulses PAc instead of the four ejection pulses PAb, includes three coupling elements EJc instead of the three coupling elements EJb, and includes a damping element EDc instead of the damping element EDb. The four ejection pulses PAc are different from the four ejection pulses PAb in that the four ejection pulses PAc include a first ejection pulse PAc1 instead of the first ejection pulse PAb1, include a second ejection pulse PAc2 instead of the second ejection pulse PAb2, include a third ejection pulse PAc3 instead of the third ejection pulse PAb3, and include a fourth ejection pulse PAc4 instead of the fourth ejection pulse PAb4.

The first ejection pulse PAc1, the second ejection pulse PAc2, the third ejection pulse PAc3, and the fourth ejection pulse PAc4 are the four ejection pulses PAc for sequentially ejecting, from the nozzle N, four droplets that coalesce after being ejected from the nozzle N and before landing on the medium M. The first ejection pulse PAc1, the second ejection pulse PAc2, the third ejection pulse PAc3, and the fourth ejection pulses PAc4 are aligned in time corresponding to the four droplets. Since the mode of coupling the four ejection pulses PAc and the three coupling elements EJc is the same as the mode of coupling the four ejection pulses PAb and the three coupling elements EJb, the description thereof will be omitted.

The first ejection pulse PAc1 is different from the first ejection pulse PAb1 in that the first ejection pulse PAc1 includes a filling element EFc1 instead of the filling element EFb1, includes an electrical potential maintained element EMc1 instead of the electrical potential maintained element EMb1, and includes an ejection element ETc1 instead of the ejection element ETb1. However, the shape of the first ejection pulse PAc1 is substantially the same as the shape of the first ejection pulse PAb1.

The second ejection pulse PAc2 is different from the second ejection pulse PAb2 in that the second ejection pulse PAc2 includes a filling element EFc2 instead of the filling element EFb2, includes an electrical potential maintained element EMc2 instead of the electrical potential maintained element EMb2, and includes an ejection element ETc2 instead of the ejection element ETb2. The ejection element ETc2 is different from the ejection element ETb2 in that the ejection element ETc2 changes from the lowest electrical potential VL to an electrical potential V1c. The electrical potential V1c is between the reference electrical potential V0 and the electrical potential V1. Specifically, the electrical potential V1c is an electrical potential of about 70%. The second coupling element EJc2 maintains the electrical potential V1c.

The third ejection pulse PAc3 is different from the third ejection pulse PAb3 in that the third ejection pulse PAc3 includes a filling element EFc3 instead of the filling element EFb3, includes an electrical potential maintained element EMc3 instead of the electrical potential maintained element EMb3, and includes an ejection element ETc3 instead of the ejection element ETb3. The filling element EFc3 is different from the filling element EFb3 in that the filling element EFc3 changes from the electrical potential V1c to the lowest electrical potential VL. The ejection element ETc3 is different from the ejection element ETb3 in that the ejection element ETc3 changes from the lowest electrical potential VL to an electrical potential V2c. The electrical potential V2c is between the electrical potential V1c and the highest electrical potential VH. Specifically, the electrical potential V2c is an electrical potential of about 80%.

The fourth ejection pulse PAc4 is different from the third ejection pulse PAb3 in that the fourth ejection pulse PAc4 includes a filling element EFc4 instead of the filling element EFb4, includes an electrical potential maintained element EMc4 instead of the electrical potential maintained element EMb4, and includes an ejection element ETc4 instead of the ejection element ETb4. The filling element EFc4 is different from the filling element EFb4 in that the filling element EFc4 changes from the electrical potential V2c to the lowest electrical potential VL. The ejection element ETc4 is different from the ejection element ETb4 in that the ejection element ETc4 changes from the lowest electrical potential VL to an electrical potential V3c. The electrical potential V3c is between the electrical potential V2c and the highest electrical potential VH. Specifically, the electrical potential V3c is an electrical potential of about 91%.

Further, the fourth ejection pulse PAc4 is different from the fourth ejection pulse PAb4 in that the fourth ejection pulse PAc4 is coupled to the damping element EDc via an electrical potential maintained element EMc5, a damping expansion element EGc, an electrical potential maintained element EMc6, a damping contraction element EHc, and an electrical potential maintained element EMc7. Further, the amount of a droplet ejected based on the fourth ejection pulse PAc4 is less than the amount of a droplet ejected based on the fourth ejection pulse PAb4.

Hereinafter, each of the filling elements EFc1, EFc2, EFc3, and EFc4 may be referred to as filling element EFc. Each of the ejection elements ETc1, ETc2, ETc3, and ETc4 may be referred to as an ejection element ETC.

The ejection element ETc4 is coupled to the electrical potential maintained element EMc5 by changing from the lowest electrical potential VL to the electrical potential V3c. The electrical potential maintained element EMc5 maintains the electrical potential V3c and is coupled to the damping expansion element EGc at the ending edge of the electrical potential maintained element EMc5. The damping expansion element EGc changes from the electrical potential V3C to an electrical potential V4C to expand the pressure chamber C, and is coupled to the electrical potential maintained element EMc6 at the ending edge of the damping expansion element EGc. The electrical potential V4c is between the reference electrical potential V0 and the lowest electrical potential VL. Specifically, the electrical potential V4c is an electrical potential of about 20%. The electrical potential maintained element EMc6 maintains the electrical potential V4c and is coupled to the damping contraction element EHc at the ending edge of the electrical potential maintained element EMc6. The damping contraction element EHc changes from the electrical potential V4C to the highest electrical potential VH to contract the pressure chamber C, and is coupled to the electrical potential maintained element EMc7 at the ending edge of the damping contraction element EHc. The electrical potential maintained element EMc7 maintains the highest electrical potential VH and is coupled to the damping element EDc at the ending edge of the electrical potential maintained element EMc7.

As in the first embodiment, a period T1c_1 from the start time TS_{EFc1} of the filling element EFc1 of the first ejection pulse PAc1 to the start time TS_{ETc1} of the ejection element ETc1 of the first ejection pulse PAc1 is set to be greater than or equal to 0.3Tc and less than or equal to 0.7Tc, and is preferably as close to 0.5Tc as possible. Similarly, a period T1c_2 from the start time TS_{EFc2} of the filling element EFc2 of the second ejection pulse PAc2 to the start time TS_{ETc2} of the ejection element ETc2 of the second ejection pulse PAc2 is set to be greater than or equal to 0.3Tc and less than or equal to 0.7Tc, and is preferably as close to 0.5Tc as possible. In addition, a period T1c_3 from the start time TS_{EFc3} of the filling element EFc3 of the third ejection pulse PAc3 to the start time TS_{ETc3} of the ejection element ETc3 of the third ejection pulse PAc3 is set to be greater than or equal to 0.3Tc and less than or equal to 0.7Tc, and is preferably as close to 0.5Tc as possible. Further, a period T1c_4 from the start time TS_{EFc4} of the filling element EFc4 of the fourth ejection pulse PAc4 to the start time TS_{ETc4} of the ejection element ETc4 of the fourth ejection pulse PAc4 is set to be greater than or equal to 0.3Tc and less than or equal to 0.7Tc, and is preferably as close to 0.5Tc as possible.

In addition, an absolute value of an electrical potential change range of an ejection element ETc of a certain ejection pulse PAc among the ejection pulses PAc is greater as the certain ejection pulse PAa is supplied later. Specifically, the absolute value of the electrical potential change range of the ejection element ETc1 is V0-VL, the absolute value of the electrical potential change range of the ejection element ETc2 is V1c-VL, and V1c is higher than V0. Therefore, the absolute value of the electrical potential change range of the ejection element ETc2 is greater than the absolute value of the electrical potential change range of the ejection element ETc1. Further, the absolute value of the electrical potential change range of the ejection element ETc3 is V2c-VL, and V2c is higher than V1c. Therefore, the absolute value of the electrical potential change range of the ejection element ETc3 is greater than the absolute value of the electrical potential change range of the ejection element ETc2. Further, the absolute value of the electrical potential change range of the ejection element ETc4 is V3c-VL, and V3c is higher than V2b. Therefore, the absolute value of the electrical potential change range of the ejection element ETc4 is greater than the absolute value of the electrical potential change range of the ejection element ETc3.

In addition, the reference electrical potential V0 that is the electrical potential maintained by the first coupling element EJc1 is between the lowest electrical potential VL that is the electrical potential of the ending edge of the filling element EFc1 of the first ejection pulse PAc1 that is the first ejection pulse PAc among the four ejection pulses PAc and the electrical potential V1c maintained by the second coupling element EJc2 that is after the first coupling element EJc1.

In addition, as in the first embodiment, the reference electrical potential V0 that is the electrical potential of the ending edge of the ejection element ETc1 of the first ejection pulse PAc1 that is the first ejection pulse PAc among the four ejection pulses PAc is equal to the reference electrical potential V0 that is the electrical potential of the starting edge of the filling element EFc1. In addition, in each of the second and subsequent ejection pulses PAc among the four ejection pulses PAc, the absolute value of the electrical potential change range of the ejection element ETc is greater than the absolute value of the electrical potential change range of the filling element EFc. Specifically, the absolute value of the electrical potential change range of the ejection element ETc2 of the second ejection pulse PAc2 is V1c-VL, and the absolute value of the electrical potential change range of the filling element EFc2 is V0-VL. Therefore, the absolute value of the electrical potential change range of the ejection element ETc2 is greater than the absolute value of the electrical potential change range of the filling element EFc2. In addition, the absolute value of the electrical potential change range of the ejection element ETc3 of the third ejection pulse PAc3 is V2c-VL, the absolute value of the electrical potential change range of the filling element EFc3 is V1c-VL, and V2c is higher than V1c. In addition, the absolute value of the electrical potential change range of the ejection element ETc4 of the fourth ejection pulse PAc4 is V3c-VL, the absolute value of the electrical potential change range of the filling element EFc4 is V2c-VL, and V3c is higher than V2c. Therefore, the absolute value of the electrical potential change range of the ejection element ETc4 is greater than the absolute value of the electrical potential change range of the filling element EFc4.

In addition, as in the first embodiment, the absolute value of the electrical potential change range of the filling element EFc4 of the fourth ejection pulse PAc4 that is the last ejection pulse PAc among the four ejection pulses PAc is greater than the absolute value of the electrical potential change range of the filling element EFc1 of the first ejection pulse PAc1 that is the first ejection pulse PAc among the four ejection pulses PAc. Specifically, since the absolute value of the electrical potential change range of the filling element EFc4 is V2c-VL and the absolute value of the electrical potential change range of the filling element EFc1 is V0-VL, the absolute value of the electrical potential change range of the filling element EFc4 is greater than the absolute value of the electrical potential change range of the filling element EFc1.

In addition, the period T2c_1 of the first coupling element EJc1 that is the first coupling element EJc among the three coupling elements EJc is set to be greater than or equal to (n1−0.25)×Tc and less than or equal to (n1+0.25)×Tc, and is preferably as close to n1×Tc as possible. Similarly, the period T2c_2 of the second coupling element EJc2 that is the second coupling element EJc among the three coupling elements EJc is set to be greater than or equal to (n1−0.25)×Tc and less than or equal to (n1+0.25)×Tc, and is preferably as close to n1×Tc as possible. In addition, the period T2c_3 of the third coupling element EJc3 that is the last coupling element EJc among the three coupling elements EJc is set to be greater than or equal to (n1−0.25)×Tc and less than or equal to (n1+0.25)×Tc, and is preferably as close to n1×Tc as possible. Hereinafter, each of the periods T2c_1, T2c_2, and T2c_3 may be referred to as a period T2c.

Further, the period T2c_3 of the third coupling element EJc3 that is the last coupling element EJc among the three coupling elements EJc is greater than Tc and less than or equal to 2Tc. In the following description, the period T2c of the last coupling element EJc among the three coupling elements EJc may be referred to as a period T2cLast. In the third modification, as illustrated in FIG. 9, the period T2c_3 is the period T2cLast.

Further, the periods T2c of the coupling elements EJc other than the last coupling element EJc among the three coupling elements EJc are shorter than the period T2cLast of the last coupling element EJc. Specifically, the period T2c_1 of the first coupling element EJc1 that is the first coupling element EJc and the period T2c_2 of the second coupling element EJc2 that is the second coupling element EJc are shorter than the period T2c_3 of the third coupling element EJc3 that is the last coupling element EJc.

In addition, a time interval T3c_1 from the start time TS_{ETc1} of the ejection element ETc1 of the first ejection pulse PAc1 to the start time TS_{ETc2} of the ejection element ETc2 of the second ejection pulse PAc2 is set to be greater than or equal to (n2−0.4)×Tc and less than or equal to n2×Tc. Similarly, a time interval T3c_2 from the start time TS_{ETc2} to the start time TS_{ETc3} of the ejection element ETc3 of the third ejection pulse PAc3 is set to be greater than or equal to (n2−0.4)×Tc and less than or equal to n2×Tc. In addition, a time interval T3c_3 from the start time TS_{ETc3} to the start time TS_{ETc4} of the ejection element ETc4 of the fourth ejection pulse PAc4 is set to be greater than or equal to (n2−0.4)×Tc and less than or equal to n2×Tc.

### B4: Fourth Modification

In each of the aspects described above, negative pressure is generated in the pressure chamber C by decreasing the electrical potential supplied to the drive element 51f, and positive pressure is generated in the pressure chamber C by increasing the electrical potential supplied to the drive element 51f. However, the present disclosure is not limited thereto. For example, positive pressure may be generated in the pressure chamber C by decreasing the electrical potential supplied to the drive element 51f, and negative pressure may be generated in the pressure chamber C by increasing the electrical potential supplied to the drive element 51f. In a fourth modification, the relationship between the high and low electrical potentials of the drive signal Com in each of the aspects described above may be reversed.

Even when the relationship between the high and low electrical potentials of the drive signal Com is reversed, the absolute values of the electrical potential change ranges of the filling elements EF and the absolute values of the electrical potential change ranges of the ejection elements ET are the same as those in each of the aspects described above.

In addition, the difference between the reference electrical potential and the highest electrical potential VH of the drive signal Com in the fourth modification is greater than or equal to 50% and less than or equal to 70% of the difference between the lowest electrical potential VL and the highest electrical potential VH. In the fourth modification, the highest electrical potential VH is the most different from the reference electrical potential among electrical potentials from the lowest electrical potential VL to the highest electrical potential VH in the electrical potential range available for the at least three ejection pulses PA.

### B5: Fifth Modification

In each of the aspects described above, in the first ejection pulse PA, the electrical potential of the ending edge of the ejection element ET is equal to the electrical potential of the starting edge of the filling element EF. However, the present disclosure is not limited thereto. For example, in the first ejection pulse PA, the electrical potential of the ending edge of the ejection element ET may be different from the electrical potential of the starting edge of the filling element EF. In addition, in each of the second and subsequent ejection pulses PA among the at least three ejection pulses PA, the absolute value of the electrical potential change range of the ejection element ET is greater than the absolute value of the electrical potential change range of the filling element EF. However, the present disclosure is not limited thereto. For example, in each of the second and subsequent ejection pulses PA among the at least three ejection pulses PA, the absolute value of the electrical potential change range of the ejection element ET may be less than or equal to the absolute value of the electrical potential change range of the filling element EF.

### B6: Sixth Modification

In each of the aspects described above, the absolute value of the electrical potential change range of the filling element EF of the last ejection pulse PA among the at least three ejection pulses PA is greater than the absolute value of the electrical potential change range of the filling element EF of the first ejection pulse PA among the at least three ejection pulses PA. However, the present disclosure is not limited thereto. For example, the absolute value of the electrical potential change range of the filling element EF of the last ejection pulse PA may be less than or equal to the absolute value of the electrical potential change range of the filling element EF of the first ejection pulse PA.

### B7: Seventh Modification

In each of the aspects described above, the difference between the reference electrical potential V0 and the electrical potential most different from the reference electrical potential V0 in the electrical potential range available for the at least three ejection pulses PA is greater than or equal to 50% of the difference between the lowest electrical potential VL and the highest electrical potential VH in the electrical potential range available for the at least three ejection pulses PA and is less than or equal to 70% of the difference between the lowest electrical potential VL and the highest electrical potential VH in the electrical potential range available for the at least three ejection pulses PA. However, the present disclosure is not limited thereto. For example, the difference between the reference electrical potential V0 and the electrical potential most different from the reference electrical potential V0 in the electrical potential range available for the at least three ejection pulses PA may be less than 50% of the difference between the lowest electrical potential VL and the highest electrical potential VH in the electrical potential range available for the at least three ejection pulses PA, or may be greater than 70% of the difference between the lowest electrical potential VL and the highest electrical potential VH in the electrical potential range available for the at least three ejection pulses PA.

### B8: Eighth Modification

In each of the above-described aspects, the periods T2 are set to be greater than or equal to (n1−0.25)×Tc and less than or equal to (n1+0.25)×Tc, but are not limited thereto. For example, the periods T2 may be less than (n1−0.25)×Tc or greater than (n1+0.25)×Tc.

### B9: Ninth Modification

In each of the above-described aspects, the period T2Last of the last coupling element among the at least two coupling elements EJ is greater than Tc and less than or equal to 2Tc, but is not limited thereto. For example, the period T2Last may be less than or equal to Tc or may be greater than 2Tc.

### B10: Tenth Modification

In each of the aspects described above, the period of the coupling element EJ other than the last coupling element EJ among the at least two coupling elements EJ is shorter than the period T2Last of the last coupling element EJ. However, the present disclosure is not limited thereto. For example, the period of the coupling element EJ other than the last coupling element EJ among the at least two coupling elements EJ may be greater than or equal to the period T2Last.

### B11: Eleventh Modification

In each of the aspects described above, the time interval T3 between the start of ejection elements ET of two consecutive ejection pulses PA among at the least three ejection pulses PA is set to be greater than or equal to (n2−0.4)×Tc and less than or equal to n2×Tc, but is not limited thereto. For example, each of the time intervals T3 may be less than (n2−0.4)×Tc or greater than n2×Tc.

### B12: Twelfth Modification

In each of the first embodiment and the first modification, the drive signal Com includes three ejection pulses PA corresponding to three droplets. In the second modification and the third modification, the drive signal Com includes four ejection pulses PA corresponding to four droplets. However, the present disclosure is not limited thereto. For example, the drive signal Com may include five or more ejection pulses corresponding to five or more droplets.

### B13: Thirteenth Modification

In each of the aspects described above, the serial type liquid ejecting apparatus 100 in which the carriage 41 on which the head 50 is mounted reciprocates is exemplified. However, the present disclosure is also applied to a line type liquid ejecting apparatus in which a plurality of nozzles N are distributed over the entire width of the medium M.

### B14: Fourteenth Modification

The liquid ejecting apparatus 100 exemplified in each of the aspects described above may be employed in various apparatuses such as a facsimile apparatus and a copy machine in addition to an apparatus dedicated to printing, and the application of the present disclosure is not particularly limited. However, the application of the liquid ejecting apparatus is not limited to printing. For example, a liquid ejecting apparatus that ejects a solution of a coloring material is used as a manufacturing apparatus that forms a color filter for a display device such as a liquid crystal display panel. In addition, a liquid ejecting apparatus that ejects a solution of a conductive material is used as a manufacturing apparatus that forms wiring or an electrode for a wiring substrate. Furthermore, a liquid ejecting apparatus that ejects a solution of an organic substance related to a living body is used, for example, as a manufacturing apparatus that manufactures a biochip.

What is claimed is:

1. A liquid ejecting apparatus comprising:
an ejection section including a nozzle from which a droplet is ejected to cause the droplet to land on a medium, a pressure chamber communicating with the nozzle, and a drive element that is configured to change pressure applied to liquid in the pressure chamber when a drive signal is supplied to the drive element; and
a drive signal generator that is configured to generate the drive signal, wherein
the drive signal includes, in a unit period,
at least three ejection pulses corresponding to at least three droplets that coalesce before landing on the medium, each of the at least three ejection pulses including a filling element that changes an electrical potential to generate negative pressure in the pressure chamber, and an ejection element that changes an electrical potential to generate positive pressure in the pressure chamber and eject a droplet from the nozzle,
at least two coupling elements that couple consecutive ejection pulses among the at least three ejection pulses while maintaining an electrical potential, and
a damping element that attenuates residual vibration of the liquid in the pressure chamber by generating negative pressure in the pressure chamber after the droplets are ejected from the nozzle after a last ejection pulse among the at least three ejection pulses,
when a natural vibration period of the ejection section is Tc,
a period from start of the filling element to start of the ejection element in each of the at least three ejection pulses is set to be greater than or equal to 0.3Tc and less than or equal to 0.7Tc,
an absolute value of an electrical potential change range of each ejection element of the at least three ejection pulses is set so that the absolute values of the electrical potential change ranges of the ejection elements of the at least three ejection pulses are great sequentially in order of time in the unit period,
each of the at least two coupling elements maintains an electrical potential of an ending edge of an ejection element of a preceding ejection pulse out of corresponding the consecutive ejection pulses, and is coupled to a starting edge of a filling element of a subsequent ejection pulse out of the corresponding consecutive ejection pulses, and
an electrical potential maintained by each of the at least two coupling elements is set so that the electrical potentials maintained by the at least two coupling elements are, in order of time in the unit period, sequentially close to an electrical potential of an ending edge of a filling element of the last ejection pulse.

2. The liquid ejecting apparatus according to claim 1, wherein
in a first ejection pulse among the at least three ejection pulses, an electrical potential of an ending edge of the ejection element is equal to an electrical potential of a starting edge of the filling element, and
in each of a second and subsequent ejection pulses among the at least three ejection pulses, an absolute value of an electrical potential change range of the ejection element is greater than an absolute value of an electrical potential change range of the filling element.

3. The liquid ejecting apparatus according to claim 1, wherein
an absolute value of an electrical potential change range of the filling element of the last ejection pulse among the at least three ejection pulses is greater than an absolute value of an electrical potential change range of the filling element of a first ejection pulse among the at least three ejection pulses.

4. The liquid ejecting apparatus according to claim 1, wherein
a electrical potential at start of the unit period of the drive signal is a reference electrical potential,
a difference between the reference electrical potential and an electrical potential most different from the reference electrical potential among electrical potentials in an electrical potential range available for the at least three ejection pulses is greater than or equal to 50% and less than or equal to 70% of a difference between a lowest electrical potential and a highest electrical potential in the electrical potential range.

5. The liquid ejecting apparatus according to claim 1, wherein
periods of the at least two coupling elements are set to be greater than or equal to (n1−0.25)×Tc and less than or equal to (n1+0.25)×Tc, where
n1 is an integer greater than or equal to 1.

6. The liquid ejecting apparatus according to claim 1, wherein
a period of a last coupling element among the at least two coupling elements is greater than Tc and less than or equal to 2Tc.

7. The liquid ejecting apparatus according to claim 1, wherein
a period of the coupling element that is among the at least two coupling elements and is not a last coupling element among the at least two coupling elements is shorter than a period of the last coupling element.

8. The liquid ejecting apparatus according to claim 1, wherein
a time interval between start of an ejection element of one of two consecutive ejection pulses among the at least three ejection pulses and start of an ejection element of the other of the two consecutive ejection pulses is set to be greater than or equal to (n2−0.4)×Tc and less than or equal to n2×Tc, where
n2 is an integer greater than or equal to 2.

9. A method of driving a liquid ejecting apparatus including
an ejection section including a nozzle from which a droplet is ejected to cause the droplet to land on a medium, a pressure chamber communicating with the nozzle, and a drive element that is configured to change pressure applied to liquid in the pressure chamber when a drive signal is supplied to the drive element, and
a drive signal generator that is configured to generate the drive signal, wherein
the drive signal includes, in a unit period,
at least three ejection pulses corresponding to at least three droplets that coalesce before landing on the medium, each of the at least three ejection pulses including a filling element that changes an electrical potential to generate negative pressure in the pressure chamber, and an ejection element that changes an electrical potential to generate positive pressure in the pressure chamber and eject a droplet from the nozzle,
at least two coupling elements that couple consecutive ejection pulses among the at least three ejection pulses while maintaining an electrical potential, and
a damping element that attenuates residual vibration of the liquid in the pressure chamber by generating negative pressure in the pressure chamber after the droplets are ejected from the nozzle after a last ejection pulse among the at least three ejection pulses,
when a natural vibration period of the ejection section is Tc,
a period from start of the filling element to start of the ejection element in each of the at least three ejection pulses is set to be greater than or equal to 0.3Tc and less than or equal to 0.7Tc,
an absolute value of an electrical potential change range of each ejection element of the at least three ejection pulses is set so that the absolute values of the electrical potential change ranges of the ejection elements of the at least three ejection pulses are great sequentially in order of time in the unit period,
each of the at least two coupling elements maintains an electrical potential of an ending edge of an ejection element of a preceding ejection pulse out of corresponding the consecutive ejection pulses, and is coupled to a starting edge of a filling element of a subsequent ejection pulse out of the corresponding consecutive ejection pulses, and
an electrical potential maintained by each of the at least two coupling elements is set so that the electrical potentials maintained by the at least two coupling elements are, in order of time in the unit period, sequentially close to an electrical potential of a filling element of the last ejection pulse.
